(19) United States
(12) Patent Application Publication
(10) Pub. No.: US 2019/0246240 A1
(43) Pub. Date: Aug. 8, 2019

(54) Application and User Interfaces for Information Technology Services

(71) Applicant: ServiceNow, Inc., Santa Clara, CA (US)

(72) Inventors: Darius Koohmarey, Poway, CA (US); Daniel Kong, San Diego, CA (US); Daryl John Rodrigues, San Diego, CA (US); Marcus Alday, San Diego, CA (US); Anthony Arobone, San Diego, CA (US)

(21) Appl. No.: 15/890,014

(22) Filed: Feb. 6, 2018

(51) Int. Cl. H04W 4/029; H04L 12/24; H04W 8/00

(52) U.S. Cl. CPC H04W 4/029; H04W 8/005; H04L 41/5061

(57) ABSTRACT

An example system includes a database storing a queue of entries indicating technical issues to be addressed at a walk-up location. The system also includes a queue management software module configured to: receive, from a computing device, a request to insert a first entry into the queue; monitor a travel time between a location of the computing device and the walk-up location; determine a wait time until the first entry reaches a predetermined position within the queue; in response to the travel time meeting or exceeding the wait time, transmit a notification to the computing device instructing to depart for the walk-up location; determine an arrival time at the walk-up location based on updated locations of the computing device following the departure; adjust a position of the first entry within the queue based on the arrival time; and assign the first entry for service at the walk-up location.

### BACKGROUND

Providing information technology (IT) services may involve diagnosing, mitigating, and resolving various incidents that are not part of the standard IT operations of an enterprise. Timely resolution of incidents is important to ensuring high levels of service quality and availability of the IT services. Users experiencing technical issues may seek assistance through various assistance channels such a phone support, chat support, email support, and walk-up support. Channels offering remote technical support, such as phone, chat, and email, may be convenient, but limit the extent of the interaction between the technician and the user seeking assistance. On the other hand, walk-up support may allow for more extensive and efficient interaction between the technician and user due to the physical presence of the user and the user's computing device at the walk-up location.

### SUMMARY

A walk-up location offering technical support may, under some circumstances, be able to provide more effective technical support than other technical support channels such as phone, chat, or email. The walk-up location may be more effective at providing technical support because the physical presence of the requestor (i.e., the user requesting technical assistance) and the requestor's computing devices at the walk-up location may allow the technician to more easily understand and diagnose the issue. In addition, when the user requests an item found in inventory at the walk-up location, the item may be provided to the user without shipping or delivery delay. However, operating the walk-up location may involve synchronizing the availability of technicians with the arrival times of requestors so that neither is left standing idly by while waiting for the other. Reducing requestor wait time at a walk-up location may be particularly important in an enterprise setting since the cost of such idle time may fall on the enterprise. That is, when the enterprise offers the walk-up location to its employees, increased wait times may cause decreased employee productivity. Similarly, when the enterprise offers the walk-up location to its customers, increased wait times may cause decreased customer satisfaction.

Accordingly, a system, which includes user-facing software applications and corresponding server back-end software modules, may be used to facilitate synchronization between the technicians at the walk-up location and requestors seeking assistance therefrom. A requestor may, by way of a user interface provided by the software application, submit a description of their issue to be entered into a queue of entries or incidents to be addressed at the walk-up location. Notably, the requestor may do this while they are away from the walk-up location. The application may, using a location of the requestor's computing device as a proxy for the location of the requestor, monitor a travel time between the requestor's location and the walk-up location. The application may additionally monitor a wait time for the requestor's entry to reach a predetermined position within the queue (e.g., a head of the queue). When the travel time meets or exceeds the wait time, the system may transit a notification to the requestor's computing device instructing the requestor to depart for the walk-up location. The requestor's departure may thus be timed to approximately (e.g., to within 5 minutes) synchronize with availability of a technician at the walk-up location, thereby allowing the requestor to avoid having to wait at the walk-up location as the requestor's entry makes its way up the queue.

Additionally, as the requestor travels towards the walk-up location, the system may continue to monitor the requestor's time until arrival (i.e., arrival time) based on updates in the requestor's location, and wait time based on updates to the position of the requestor's entry within the queue. The system may adjust the position of the entry within the queue based on the arrival time to account for the requestor running early or late. Thus, when the requestor is running late, the requestor's entry may be automatically moved down in the queue, allowing available technicians to help other requestors. Similarly, when the requestor is running early, the requestor's entry may be automatically moved up in the queue, thereby increasing the likelihood that a technician is available to assist upon the requestor's arrival. When the requestor arrives at the walk-up location, their entry may be assigned to a technician for service, thus reducing requestor and technician idle time.

The system may additionally provide a fulfiller application to be used by the technicians to assign entries in the queue for service, close or resolve entries, and abandon entries for which a requestor is not present. Further, the fulfiller application may be used, in combination with the back-end software modules, to divide a requestor's issue up into one or more tasks to be completed by technicians and to locate, reserve, or order catalog items for the requestor. Completion of the tasks and procurement or obtainment of the catalog items may be expected to resolve at least part of the requestor's issue. Each of the tasks and catalog items may be mapped back to the requestor's entry to keep the workflow organized and to be able to provide the requestor with notifications as to the status of their issue as tasks are completed and catalog items obtained.

Notably, resolution of IT incidents may often involve performing diagnostic operations at various layers or components of the IT infrastructure (applications, operating systems, middleware, network, storage, server, etc.), some of which may be maintained by different organizations or departments within the enterprise. Thus, incident resolution may involve dedicating a significant portion of available repair time to coordinating efforts of the different organizations in order to diagnose the issue and implement a solution. The system herein described may facilitate a reduction in the proportion of repair time spent on coordinating different organizations within the enterprise by providing for integration between the different organizations.

The system may allow for the various tasks and catalog items to be assigned to or requested from, respectively, different organizations within the enterprise. The walk-up location technicians may, for example, request that a member of the purchasing department order a new computer for a requestor. In another example, the technician may request, by creating and assigning a task, that a member of the network infrastructure install a new wireless router near the requestor's office to replace one that is malfunctioning. In yet another example, the technician may request, by creating and assigning a task, that a member of the human resources (HR) department provide a requestor with access to the HR software platform. The walk-up location may thus operate to address a variety of technical issues across multiple organizations without having to directly interact with technicians within these organizations.

Accordingly, a first example embodiment may involve a computing system disposed within a computational instance of a remote network management platform that remotely manages a managed network. The computing system may include a database storing a queue of entries for a walk-up location co-located with the managed network. The entries indicate technical issues to be addressed at the walk-up location. The system may also include a queue management software module configured to receive, from a computing device, a request to insert a first entry into the queue. The queue management software module may also be configured to insert the first entry into the queue. The queue management software module may additionally be configured to monitor a travel time between a location of the computing device and the walk-up location and to determine a wait time until the first entry reaches a predetermined position within the queue. The queue management software module may yet additionally be configured to, in response to the travel time meeting or exceeding the wait time, transmit a notification to the computing device. Reception of the notification by the computing device causes the computing device to display an instruction to depart for the walk-up location. The queue management software module may further be configured to determine an arrival time of the computing device at the walk-up location based on updated locations of the computing device following the departure and to adjust a position of the first entry within the queue based on the arrival time. The queue management software module may be configured to assign the first entry for service at the walk-up location based on the computing device arriving at the walk-up location.

In a second example embodiment, a method may involve receiving, from a computing device and by a computational instance of a remote network management platform that remotely manages a managed network, a request to insert a first entry into a queue of entries for a walk-up location co-located with the managed network. The entries indicate technical issues to be addressed at the walk-up location. The method may also involve inserting, by the computational instance, the first entry into the queue. The method may additionally involve monitoring, by the computational instance, a travel time between a location of the computing device and the walk-up location and determining, by the computational instance, a wait time until the first entry reaches a predetermined position within the queue. The method may yet additionally involve, in response to the travel time meeting or exceeding the wait time, transmitting, by the computational instance, a notification to the computing device. Reception of the notification by the computing device causes the computing device to display an instruction to depart for the walk-up location. The method may further involve determining, by the computational instance, an arrival time of the computing device at the walk-up location based on updated locations of the computing device following the departure and adjusting, by the computational instance, a position of the first entry within the queue based on the arrival time. The method may yet further involve, based on the computing device arriving at the walk-up location, assigning, by the computational instance, the first entry for service at the walk-up location.

In a second example embodiment, an article of manufacture may include a non-transitory computer-readable medium, having stored thereon program instructions that, upon execution by a computing system, cause the computing system to perform operations in accordance with the first example embodiment or the second example embodiment.

In a third example embodiment, a computing system may include at least one processor, as well as memory and program instructions. The program instructions may be stored in the memory, and upon execution by the at least one processor, cause the computing system to perform operations in accordance with the first example embodiment or the second example embodiment.

In a fourth example embodiment, a system may include various means for carrying out each of the operations of the first example embodiment or the second example embodiment.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIGS. 6A and 6B depict user interfaces, in accordance with example embodiments.

FIG. 7 depicts another user interface, in accordance with example embodiments.

FIGS. 8A, 8B, 8C, and 8D depict message diagrams for managing a queue, in accordance with example embodiments.

FIG. 9 is a flow chart, in accordance with example embodiments.

FIG. 10 is an additional user interface, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its business, innovate, and meet regulatory requirements. The enterprise may find it difficult to integrate, streamline and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflow for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data is stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

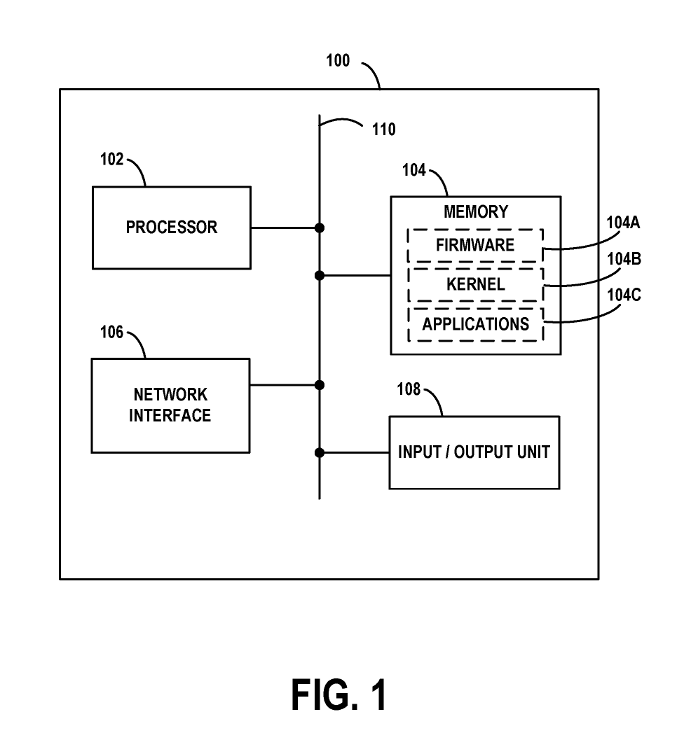

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and an input/output unit 108, all of which may be coupled by a system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and busses), of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with example computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more instances of computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

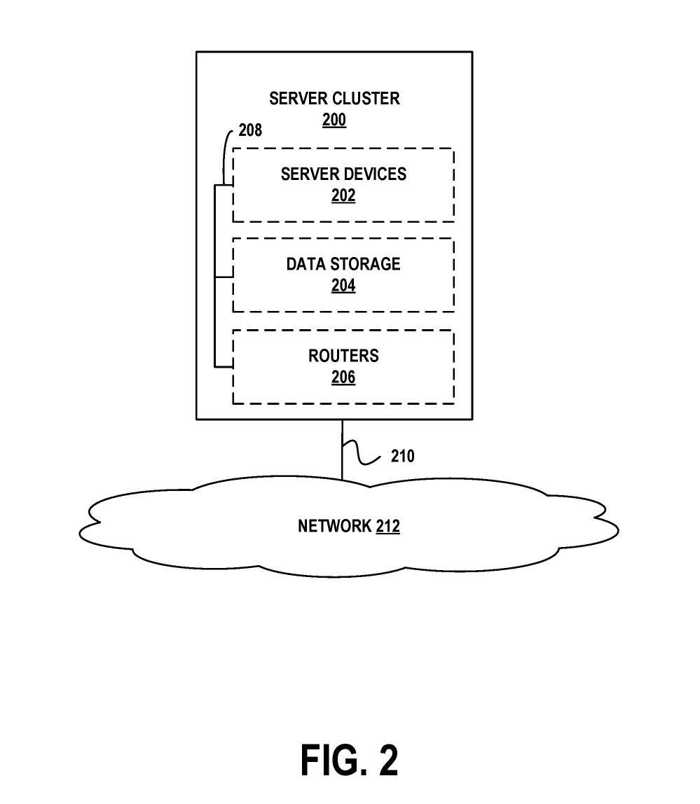

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purpose of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of cluster data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via cluster network 208, and/or (ii) network communications between the server cluster 200 and other devices via communication link 210 to network 212.

Additionally, the configuration of cluster routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from cluster data storage 204. This transmission and retrieval may take the form of SQL queries or other types of database queries, and the output of such queries, respectively. Additional text, images, video, and/or audio may be included as well. Furthermore, server devices 202 may organize the received data into web page representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### III. EXAMPLE REMOTE NETWORK MANAGEMENT ARCHITECTURE

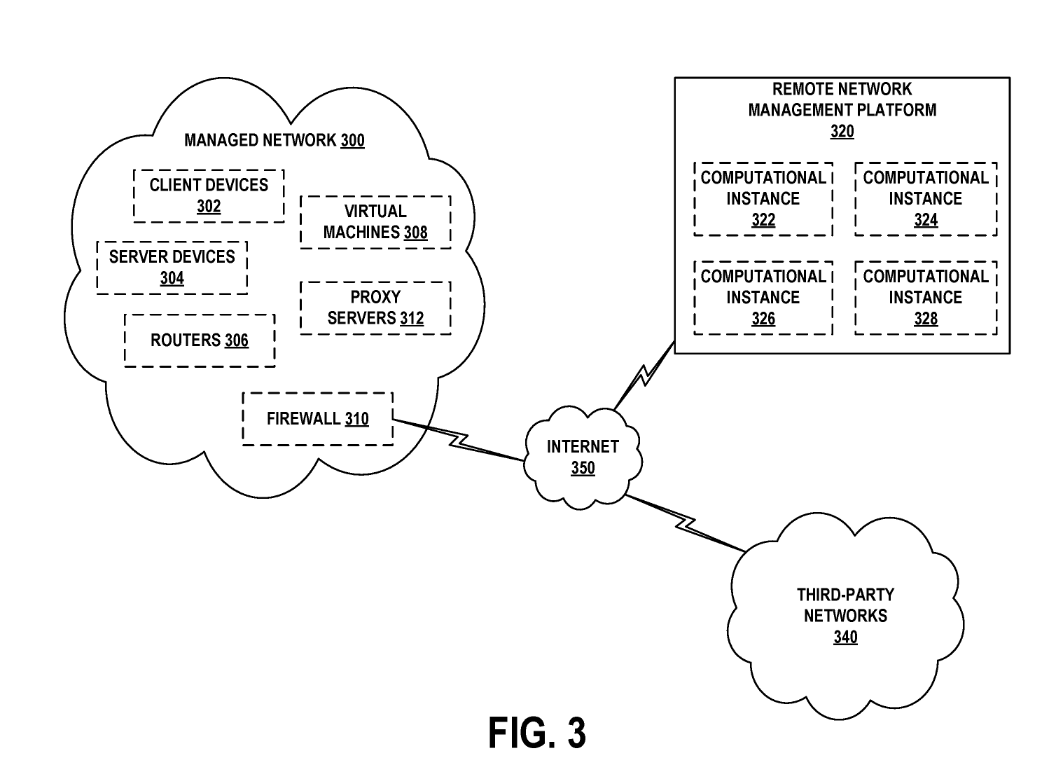

FIG. 3 depicts a remote network management architecture, in accordance with example embodiments. This architecture includes three main components, managed network 300, remote network management platform 320, and third-party networks 340, all connected by way of Internet 350.

Managed network 300 may be, for example, an enterprise network used by a business for computing and communications tasks, as well as storage of data. Thus, managed network 300 may include various client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server device that facilitates communication and movement of data between managed network 300, remote network management platform 320, and third-party networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of third-party networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

Remote network management platform 320 is a hosted environment that provides aPaaS services to users, particularly to the operators of managed network 300. These services may take the form of web-based portals, for instance. Thus, a user can securely access remote network management platform 320 from, for instance, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these instances may represent a set of web portals, services, and applications (e.g., a wholly-functioning aPaaS system) available to a particular customer. In some cases, a single customer may use multiple computational instances. For example, managed network 300 may be an enterprise customer of remote network management platform 320, and may use computational instances 322, 324, and 326. The reason for providing multiple instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation.

The multi-instance architecture of remote network management platform 320 is in contrast to conventional multi-tenant architectures, over which multi-instance architectures have several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In order to support multiple computational instances in an efficient fashion, remote network management platform 320 may implement a plurality of these instances on a single hardware platform. For example, when the aPaaS system is implemented on a server cluster such as server cluster 200, it may operate a virtual machine that dedicates varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

Third-party networks 340 may be remote server devices (e.g., a plurality of server clusters such as server cluster 200) that can be used for outsourced computational, data storage, communication, and service hosting operations. These servers may be virtualized (i.e., the servers may be virtual machines). Examples of third-party networks 340 may include AMAZON WEB SERVICES® and MICROSOFT® Azure. Like remote network management platform 320, multiple server clusters supporting third-party networks 340 may be deployed at geographically diverse locations for purposes of load balancing, redundancy, and/or high availability.

Managed network 300 may use one or more of third-party networks 340 to deploy applications and services to its clients and customers. For instance, if managed network 300 provides online music streaming services, third-party networks 340 may store the music files and provide web interface and streaming capabilities. In this way, the enterprise of managed network 300 does not have to build and maintain its own servers for these operations.

Remote network management platform 320 may include modules that integrate with third-party networks 340 to expose virtual machines and managed services therein to managed network 300. The modules may allow users to request virtual resources and provide flexible reporting for third-party networks 340. In order to establish this functionality, a user from managed network 300 might first establish an account with third-party networks 340, and request a set of associated resources. Then, the user may enter the account information into the appropriate modules of remote network management platform 320. These modules may then automatically discover the manageable resources in the account, and also provide reports related to usage, performance, and billing.

Internet 350 may represent a portion of the global Internet. However, Internet 350 may alternatively represent a different type of network, such as a private wide-area or local-area packet-switched network.

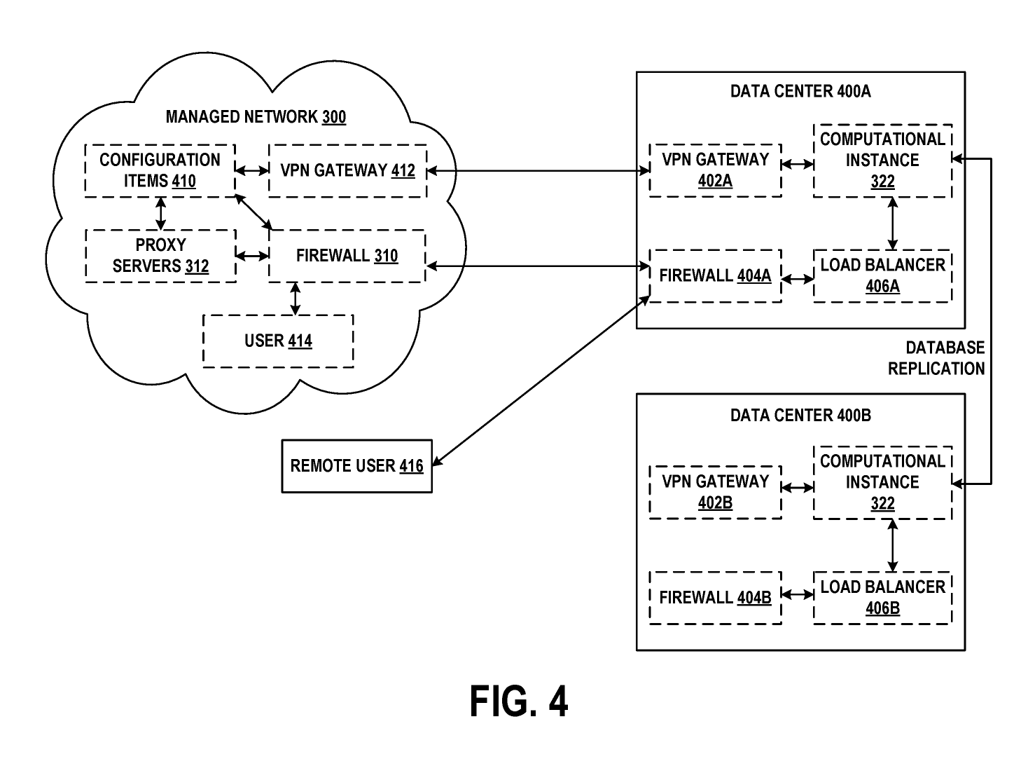

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE, APPLICATION, AND SERVICE DISCOVERY

In order for remote network management platform 320 to administer the devices, applications, and services of managed network 300, remote network management platform 320 may first determine what devices are present in managed network 300, the configurations and operational statuses of these devices, and the applications and services provided by the devices, and well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purpose of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

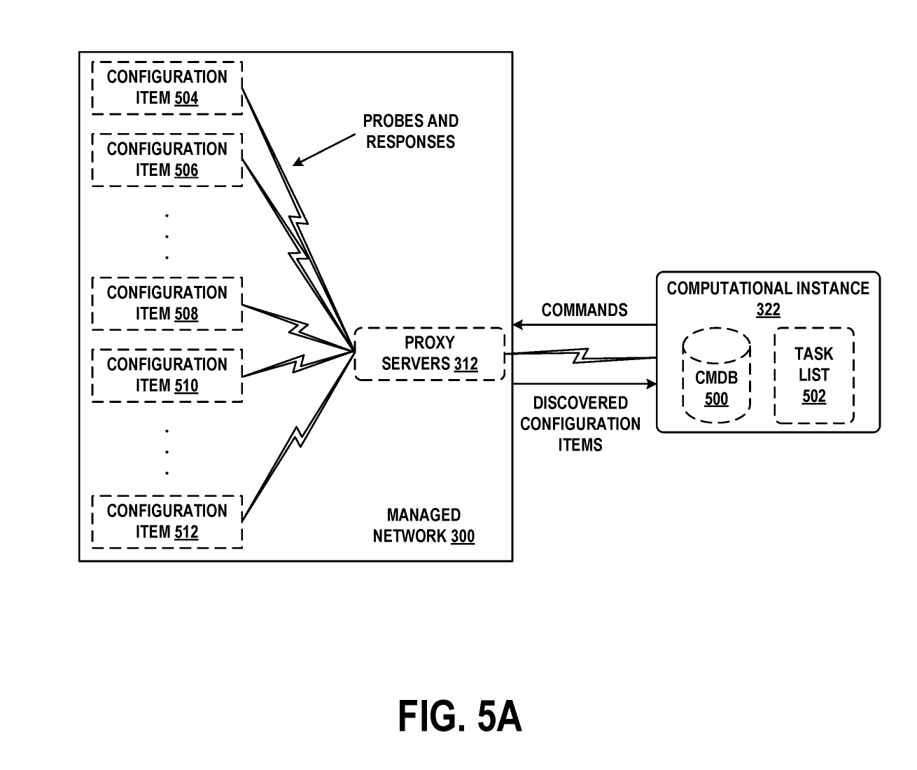

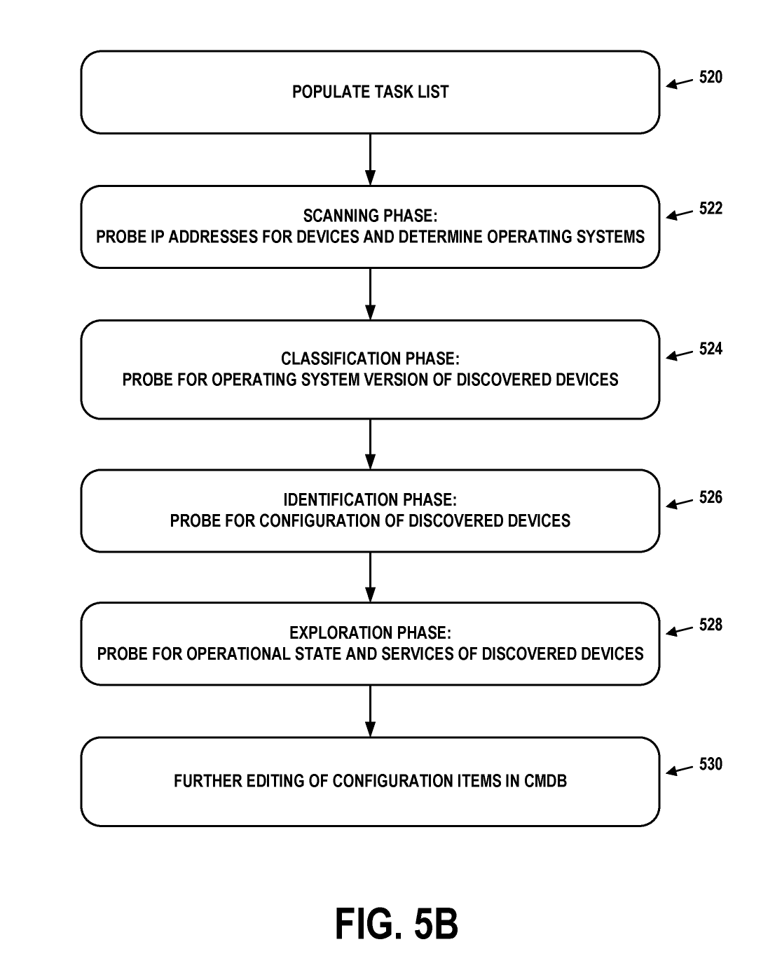

FIG. 5A provides a logical depiction of how configuration items can be discovered, as well as how information related to discovered configuration items can be stored. For sake of simplicity, remote network management platform 320, third-party networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For instance, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are for purpose of example. Discovery may be a highly configurable procedure that can have more or fewer phases, and the operations of each phase may vary. In some cases, one or more phases may be customized, or may otherwise deviate from the exemplary descriptions above.

### V. EXAMPLE USER INTERFACES FOR INTERACTING WITH A QUEUE OF TECHNICAL ISSUES

An enterprise that operates managed network 300 or is otherwise associated therewith may provide a walk-up location where users within or associated with managed network 300 can receive live, in-person technical support regarding technical issues the users may face. Providing such a walk-up location may involve coordination of technical support staff based on varying levels of demand from the users within managed network 300. Such coordination may involve determining the number of support technicians assigned to different walk-up locations, as well as determining how to assign user issues among the technical support staff members at a particular walk-up location or among staff within different departments of the enterprise. To that end, described herein are example embodiments of a software application and user interfaces associated therewith for integration of different back-end systems within managed network 300 by way of a rules-based workflow.

Among other operations, the software application may allow users to check-in and report their technical issues to the technical support staff of the walk-up location by adding themselves to a queue (i.e., a virtual queue defined in software). The check-in and issue reporting process may take place at the walk-up location, using one or more computing devices at the walk-up location, or remotely, using one or more computing devices associated with the user (e.g., the user's cell phone or office computer). A corresponding wait time may be determined for each checked-in user based on the user's position in the queue. Users may view the queue before checking in and, based on the state of the queue, determine whether to add themselves to the queue or schedule an appointment for a later time. Similarly, after adding themselves to the queue, users may monitor the queue to plan their arrival at the walk-up location based on their expected wait time.

The technical support staff may use the software application to (i) indicate that they are initiating work on an issue in the queue, (ii) close a resolved issue, (iii) abandon an issue for which a user is not present, (iv) generate one or more tasks that may need to be completed to resolve a given user's issue, and/or (v) generate requests for one or more catalog items that may need to be procured or obtained to resolve the given user's issue. Each user issue reported in the queue may be, automatically or manually, broken down into a plurality of tasks and/or catalog items that, when successfully addressed or procured, may facilitate resolution of the user issue. The tasks and catalog items may be planned to be completed or ordered by the technical staff at the walk-up location and/or technical staff within other departments or technical support organizations within managed network 300 or remote network management platform 320. Thus, the software application may assist with automatically coordinating multiple entities and/or sub-entities associated with managed network 300 to resolve a single user issue, without requiring the user or the technical staff to contact or manually coordinate the efforts of the multiple entities and/or sub-entities.

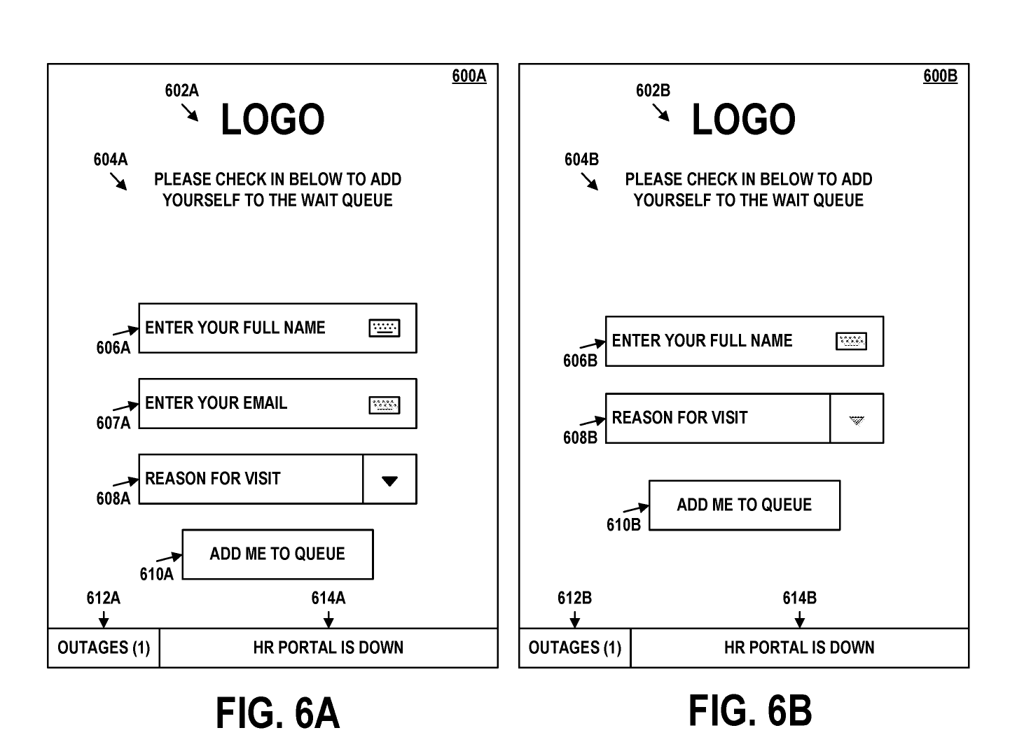

FIGS. 6A and 6B illustrate example user interfaces 600A and 600B, respectively, which may be used to facilitate the check-in process for a walk-up location. User interfaces 600A and 600B may include, respectively, logos 602A and 602B, indicators 604A and 604B directing users to use the forms below to add themselves to the walk-up queue, name boxes 606A and 606B, reason for visit boxes 608A and 608B, form submission buttons 610A and 610B, outage indicators 612A and 612B, and outage details 614A and 614B. In some implementations, some of these components of user interfaces 600A and 600B may be omitted, and additional components that are not herein shown may be added.

Logos 602A and 602B may be configurable to display a logo, banner, or other visual representation associated with managed network 300 by which the walk-up location management application is deployed. Outage indicators 612A and 612B, as well as outage details 614A and 614B, may provide users with information regarding currently known outages associated with managed network 300 and/or remote network management platform 320, or any other outages that may impact the users. Thus, informed of such outages, users might not redundantly report or ask for help with already-known issues which the technical staff is already likely working to resolve.

User interface 600A may be used, for example, to check in guest users that are not directly associated with the enterprise (e.g., customers of the enterprise, a technician on-site at a location of the enterprise) and may thus include an email box 607A for the user to provide, for example, an email at which they would like to receive updates regarding their position in the queue and the status of their issue. User interface 600B, on the other hand, may be used to check in users that are directly associated with the enterprise (e.g., employees of the enterprise). Each user's name might be associated with corresponding contact info, stored within a database accessible by managed network 300 and/or remote network management platform 320, and users thus might not have to provide any additional information besides their name (e.g., in box 606B) and a description of their issue (e.g., in box 608B) to insert an entry into a queue of a walk-up location. In some implementations, name box 606B may be associated with an auto-fill or auto-complete feature that suggests possible user identities based on one or more initial letters of the user's name, thus further facilitating the check-in process.

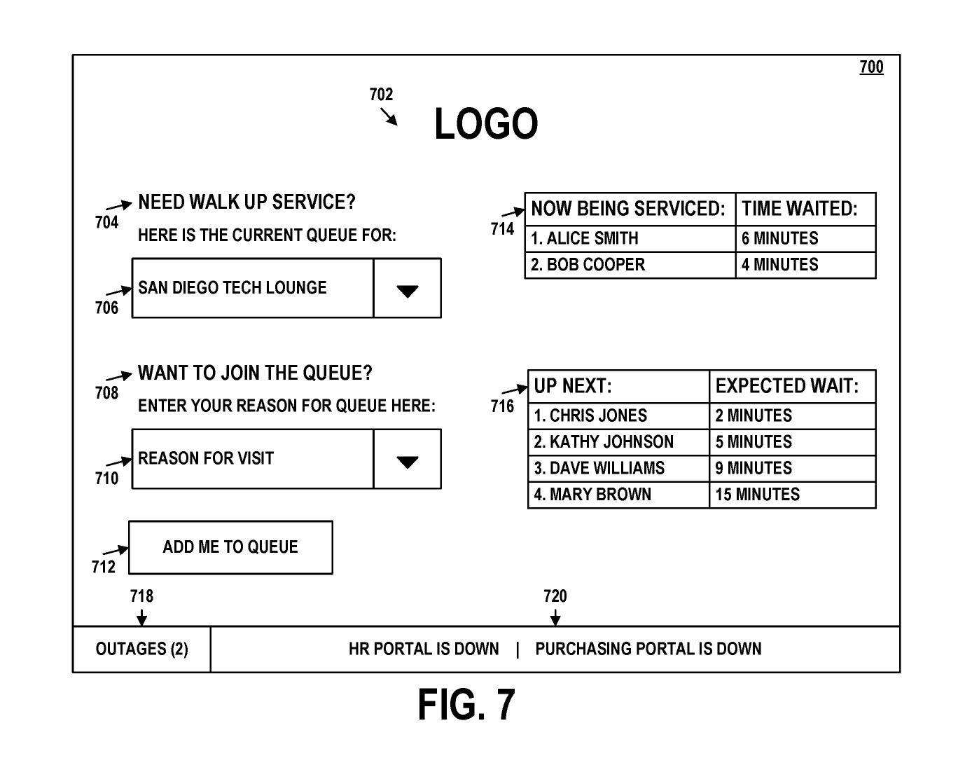

FIG. 7 illustrates another example user interface 700 that may be used to inform the users of the status of one or more walk-up support location queues and to add themselves to the one or more walk-up support location queues. Notably, user interface 700 may be used with a computing device associated with the user seeking walk-up assistance and thus might not require the user to identify themselves while adding themselves to the queue. For example, the user may be logged-in to a website or web service (e.g., a website associated with the walk-up location) provided by or otherwise associated with managed network 300 or remote network management platform 320 and their identity might therefore be known.

User interface 700 may include logo 702, indicator 704 directing users to select the current walk-up location for which the queue is shown, box 706 for selecting a walk-up location for which to show the queue, indicator 708 directing users to enter the users' reason for seeking assistance from the walk-up location, box 710 for selecting or entering the reason for seeking assistance from the walk-up location, and button 712 for submitting the user's request to be added to the queue of the selected walk-up location. User interface 700 may further include outage indicator 718 and outage details 720 to inform users of currently known outages (which may be the same as outages indicated by outage indicators 612A and 612B and outage details 614A and 614B).

User interface 700 may also include list 714 (i.e., a “now serving” indicator) indicating the users who are currently being served at the walk-up location, as well as the respective times these users have waited to be served. User interface 700 may additionally include queue 716 (i.e., an “up next” indicator) indicating the users who are expected to be served next at the walk-up location, as well as the respective expected wait times until these users are served. In some implementations, some of these components of user interface 700 may be omitted, and additional components that are not herein shown may be added. For example, user interface 700 may additionally display the issue associated with each user in list 714 and queue 716. Whether user issues are displayed in this way may be configurable on a location-by-location basis.

In some embodiments, user interface 700 may be adapted to be displayed on one or more computing devices (e.g., television screens, computer monitors, tablets, etc.) at the walk-up location by displaying list 714 and queue 716 alone (i.e., without indicators 704 and 708, boxes 706 and 710, and button 712), or by displaying list 714 and queue 716 along with user interfaces 600A or 600B, for example. Thus, users at the walk-up location may be informed of the status of the walk-up location queue before and after adding themselves to the queue.

### VI. EXAMPLE OPERATIONS FOR INTERACTING WITH THE QUEUE OF TECHNICAL ISSUES

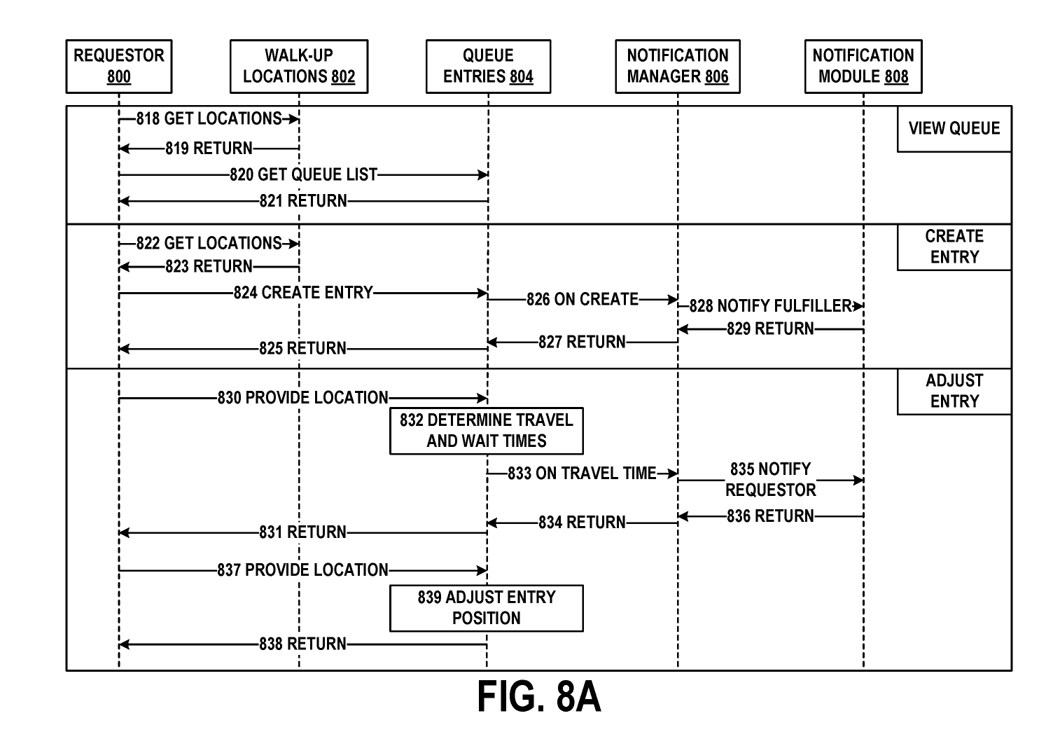

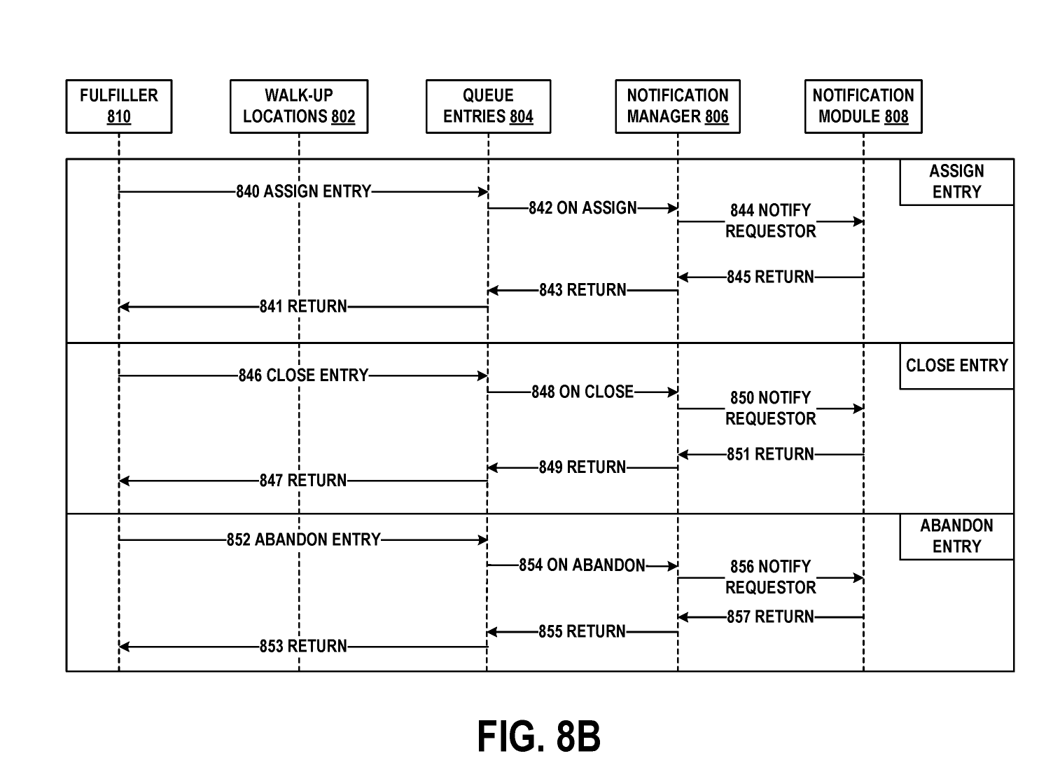

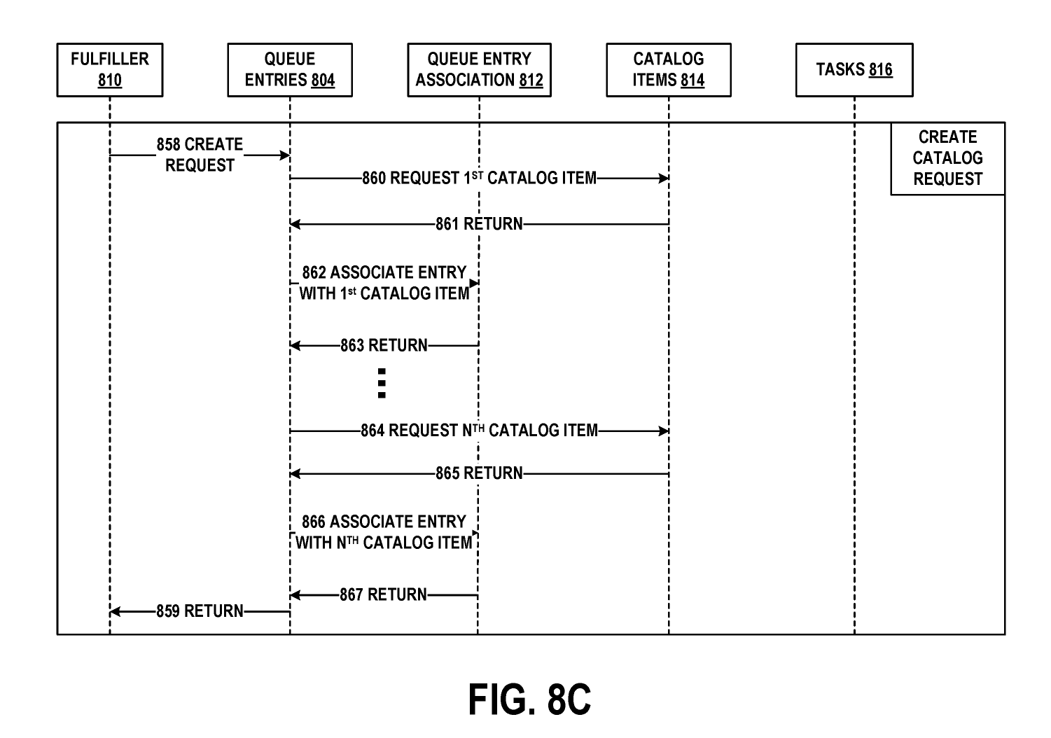

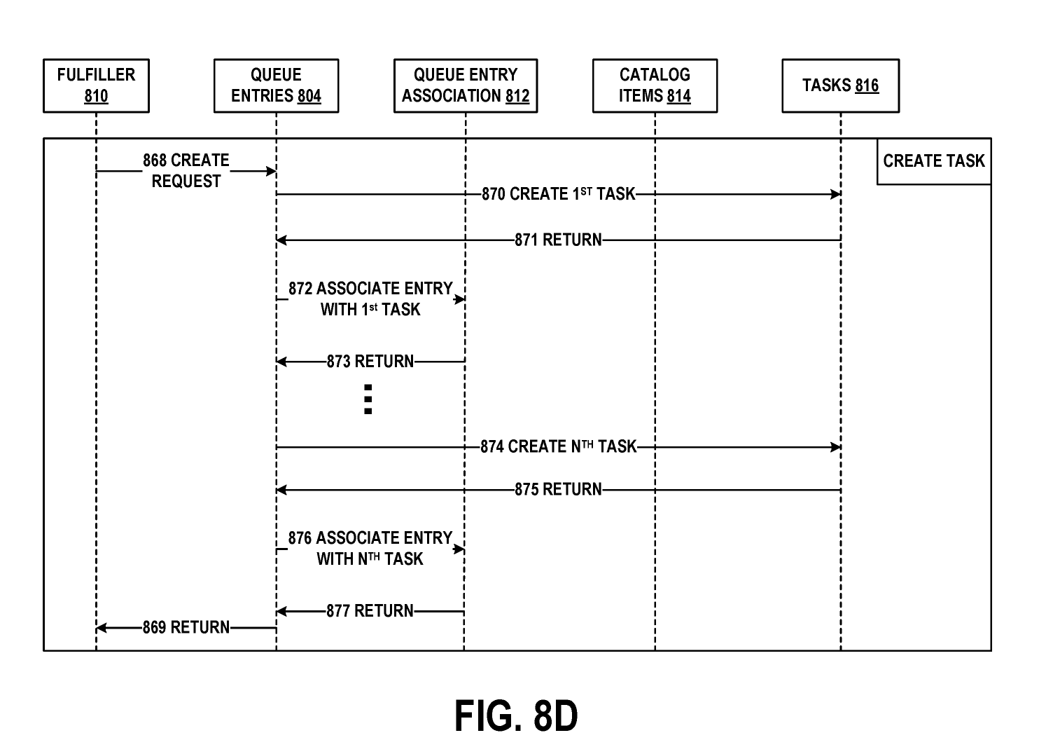

FIGS. 8A, 8B, 8C, and 8D illustrate message diagrams of example operations for managing a queue for a walk-up location. FIG. 8A illustrates requestor application 800, walk-up locations module 802, queue entries module 804, notification manager module 806, and notification module 808. Entries module 804 may also be referred to as a queue management software module. Each of these applications and modules may be hosted, executed, operated, or otherwise provided by way of one or more computational instances within remote network management platform 320 that are assigned to managed network 300, and/or by one or more computing devices within managed network 300. For example, queues for walk-up locations associated with managed network 300 or other managed networks operated by the enterprise may be operated by remote network management platform 320 on behalf of the enterprise, and the one or more computing devices within managed network 300 or the other managed networks may be used to interact with the queues.

Requestor application 800 may represent a software application configured to be used to seek technical assistance from a walk-up location associated with managed network 300 and/or remote network management platform 320. Requestor application 800 may be executed by a computing device within managed network 300 or within remote network management platform 320. Requestor application 800 may be used, for example, by an employee of an entity associated with managed network 300 to request technical assistance with one or more issues. Requestor application 800 may be a stand-alone application (i.e., executed locally by a computing device used to display the user interfaces of requestor application 800) or a web-based application (i.e., executed remotely by a server device on behalf of the computing device used to display the user interfaces of requestor application 800). Requestor application 800 may include one or more of user interfaces 600A, 600B, or 700, among other possibilities to facilitate the process of requesting the technical assistance.

In order to view the status of a queue associated with a particular walk-up location, requestor application 800 may transmit, to walk-up locations module 802 and based on user input, a request to view the list of available walk-up locations, as indicated by arrow 818. Walk-up locations module 802 may include a database which associates textual indicia of various walk-up locations with unique numerical identifiers. For example, “San Diego Tech Lounge” (or similar textual indicia) may be associated with or mapped to numerical identifier 1, “Santa Clara Tech Lounge” may be associated with or mapped to numerical identifier 2, and so on. In some implementations, the database may also associate, with each textual indicia, geographical coordinates and business hours of the corresponding walk-up location, among other possible data, to facilitate the process of selecting the appropriate walk-up location. In response to or based on the request to view the list of available walk-up locations, walk-up locations module 802 may return one or more sets of textual indicia, numerical identifier, and other associated data (e.g., geographic coordinates) for any available walk-up locations associated with the enterprise of managed network 300, as indicated by arrow 819.

Requestor application 800 may, in response, display the textual indicia of the available walk-up locations by way of, for example, user interface 700. Requestor application 800 may receive a selection of one of the available walk-up locations from the user by way of, for example, box 706 of user interface 700. Alternatively, when a computing device used to view the queue is associated with a particular walk-up location, the particular walk-up location may be automatically preset or selected from the list of available walk-up locations. Thus, users using a location-specific computing device (e.g., a tablet device located at and operated by a particular walk-up location) to add themselves to the queue may be automatically shown and/or added to the correct queue for the particular walk-up location.

The selected walk-up location, including the numerical identifier thereof, may be transmitted by requestor application 800 to queue entries module 804, as indicated by arrow 820. Queue entries module 804 may include a database of various technical issues reported and/or assigned to the different walk-up locations stored in walk-up locations module 802 (e.g., all of the walk-up locations corresponding to managed network 300). The numerical identifier of the selected walk-up location may be used to select, from queue entries module 804, queue entries associated with the selected walk-up location. A queue entry (i.e., “entry” for short) may be a database record of a reported technical issue and may include a description of the technical issue along with various metadata such as, for example, an identifier of the user who submitted the issue, the time at which the issue was submitted, and the entry's position within the queue.

The entries associated with the selected walk-up location may then be returned (i.e., transmitted) to requestor application 800, as indicated by arrow 821. In response, requestor application 800 may display one or more of the entries received from queue entries module 804 in an order dictated by each entry's position within the queue for the selected walk-up location. Alternatively, when the selected walk-up location is closed (e.g., when transmission 820 takes place outside of business hours defined for the selected walk-up location) or when technicians are not present at the selected walk-up location (e.g., when technicians are on break), queue entries module 804 may instead transmit an indication that the walk-up location is currently unavailable. This indication may include a reason for the unavailability, a schedule for the walk-up location, and/or a time at which the walk-up location is expected to reopen, among other information. Reception of this indication may cause requestor application 800 to display an “away page” representing the information contained therein.

In order to add a technical issue to a queue associated with a walk-up location (i.e., to create an entry), requestor application 800 may, in response to user input, transmit, to walk-up locations module 802, a request to view the list of available walk-up locations, as indicated by arrow 822. In response to or based on this request, walk-up locations module 802 may return one or more pairs of textual indicia and numerical identifier, among other data, for any available walk-up locations, as indicated by arrow 823. Requestor application 800 may receive, from the user and by way of the user interface, a selection of a walk-up location from the available walk-up locations, a description of the technical issue, and information identifying the user seeking assistance. In response to receiving a submission of the request (e.g., in response to the user pressing the “submit” button on the user interface), requestor application 800 may transmit this information to queue entries module 804, as indicate by arrow 824, to create a record of the issue (i.e., an entry) and request its resolution by technical staff at the walk-up location.

Queue entries module 804 may create the record of this issue in a database by associating the walk-up location's numerical identifier, the description of the user's issue, the information identifying the user, the time at which the entry was generated, and the entry's position within the walk-up location's queue, among other information. In some implementations, queue entries module 804 may be configured to automatically select a walk-up location for the user's issue based on, for example, the wait time at each available walk-up location, the user's geographic location in relation to each of the available walk-up locations, users default geographic location, and/or the technical expertise of the staff at each available walk-up location, among other possibilities. For example, the user might not be provided with a choice of walk-up locations, requestor application 800 may be used to suggest a walk-up location different from that selected by the user, or the user's chosen walk-up location may be overridden by queue entries module 804.

The queue for each walk-up location may be ordered using a number of different techniques. In one example, the queue may be a first-in-first-out queue. In another example, the queue may be prioritized, by way of a rules-based algorithm, according to attributes associated with the user seeking assistance at a walk-up location. For example, the queue may be made up of a plurality of sub-queues, with each sub-queue assigned a corresponding priority level (e.g., priority level 1, 2, or 3). Entries from queues having a higher priority (e.g., priority level 1) may be addressed before entries from queues having a lower priority (e.g., priority levels 2, or 3). In one example, entries from sub-queue with priority level 2 might be addressed once sub-queue with priority level 1 is empty, and entries from sub-queue with priority level 3 might be addressed once sub-queue with priority level 2 is empty. Alternatively, entries from the different sub-queues may be addressed in a biased round robin fashion. For example, for every four addressed issues from sub-queue with priority level 1, only two issues from sub-queue with priority level 2 and only one issue from sub-queue with priority level 3 might be addressed.

An entry may be added to one of the sub-queues based on the attributes associated with the user submitting the entry. In one example, the attributes may include a department with which the user is associated. Thus, users associated with a first department within the enterprise may be prioritized over members of a second different department within the enterprise. For example, C-Level executives (e.g., chief executive officer (CEO), chief financial officer (CFO), etc.) associated with managed network 300 may be prioritized over non-C-Level users. In another example, a user having an upcoming meeting scheduled in the user's calendar within the next hour may be prioritized over a user whose calendar does not indicate any meetings within the next hour. To that end, queue entries module 804 may be configured to communicate with one or more calendar servers associated with users within managed network 300. The queue may be ordered based on other attributes as well.

In some implementations, creation of the new entry may cause queue entries module 804 to transmit instructions to notification manager 806, as indicated by arrow 826, to provide, by way of notification module 808, a notification of the new entry to one or more computing devices associated with one or more technical staff of the walk-up location for which the new entry was created, as indicated by arrow 828. The notification module 808 may be configured to generate and transmit notifications via email, short message system (SMS), or push notifications, among other possibilities. Notification manager 806 may be configured to determine the type of notification that notification module 808 should transmit based on, for example, pre-configured preferences or settings associated with one or more of the technical staff at the walk-up location or an urgency level of the entry, among other possibilities. In some implementations, a plurality of notification modules 808 may be available, each configured to transmit a different type of notification. Notification manager 806 may thus be configured to select one or more of the plurality of notification modules 808 via which to transmit notifications based on preset preferences or settings.

Once notification module 808 transmits the notifications, it may indicate completion of transmission to notification manager 806, as indicated by arrow 829. Similarly, notification manager 806 may indicate successful completion of notification transmission to queue entries module 804, as indicated by arrow 827, and queue entries module 804 may indicate successful creation of the new entry to requestor application 800, as indicated by arrow 825. In response or based on successful creation of the new entry, requestor application 800 may display the queue, including the position of the new entry therein.

In some implementations, before, after, or while the entry is created, queue entries module 804 (or one or more other modules within the computational instance associated with managed network 300), may search a plurality of available troubleshooting guides or articles. Queue entries module 804 may, based on the description of the user's issue, identify one or more guides that are most relevant to the user's issue. The one or more guides that are most relevant to the user's issue may be identified using, for example, keyword search algorithms, machine learning algorithms, or natural language processing algorithms, among other possibilities. The most relevant guides may be transmitted from queue entries module 804 to requestor application 800 prior to or along with the indication of successful creation of the new entry, as indicated by arrow 825, and may be displayed by way of requestor application 800. This may allow the user to attempt to resolve the user's own issue while the user waits to be served at the walk-up location. Notably, the guides or articles may be provided to the user automatically, without any explicit request therefor from the user. Accordingly, any apprehension the user may have towards attempting to resolve the user's own issue may be diminished or eliminated by the automatic presentation of a relevant troubleshooting guide.

In some implementations, a queue entry indicating a technical issue may be created in response to a request submitted to queue entries module 804 by way of a computing device that is not co-located with the walk-up location. That is, the entry may be created while a user seeking technical assistance is away from the walk-up location. In order to synchronize the user's arrival at the walk-up location with a technician being available to take up the entry, the user may be notified when to start heading towards the walk-up location and, as the user travels towards the walk-up location, a position of the entry may be adjusted within the queue.

After the entry is added into the queue, requestor application 800 may transmit, to queue entries module 804, data indicative of a location of the computing device, as indicated by arrow 830. The data indicative of the location of the computing device may be determined using or based on global positioning system (GPS) data, cell tower ID, cell tower triangulation, WI-FI triangulation, inertial sensors, or near field communication (NFC) beacons, among other possibilities.

Queue entries module 804 may determine a travel time between the user's location and the walk-up location, as indicated by block 832. That is, queue entries module 804 may determine how long it will take the user to traverse the distance between the user's current position and the walk-up location while traveling at, for example, an average walking speed (e.g., 3.1 miles per hour) or a user-specific walking speed (e.g., determined based on the user's past walking speeds). In doing so, queue entries module 804 may apply one or more shortest path algorithms (e.g., Dijkstra's algorithm) to one or more maps (e.g., road maps, building maps, or building blueprints, etc.).

At block 832, queue entries module 804 may also determine a wait time until the user's entry reaches a predetermined position within the queue (e.g., head of the queue, 2^{nd} from the head of the queue, etc.). The wait time may be determined based on the severity or difficulty of resolving the types of issues indicated by the entries separating the user's entry from the predetermined position, a number of technicians available at the walk-up location, and skill levels of the available technicians, among other factors. Queue entries module 804 may, for example, extrapolate the wait time based on wait times corresponding to similar types of issues resolved in the past. To that end, queue entries module 804 may include or may have access to a database storing a plurality of issues resolved in the past. The database may store, for each issue, a record of a queue wait time, a time until resolution of the issue, and a type of classification of the issue, among other possibilities.

The travel time and the wait time may be periodically updated based on the updates in the location of the user's computing device and the state of the queue, respectively. When the travel time meets or exceeds the wait time, queue entries module 804 may transmit instructions to notification manager 806, as indicated by arrow 833, to provide, by way of notification module 808, a notification instructing the user to depart for the walk-up location, as indicated by arrow 835. The notification may be displayed by the computing device associated with the user in response to reception of the notification thereby. Transmitting the notification in this way may allow sufficient time for the user to travel to the walk-up location before their entry is taken up by a technician. The user may interact with the received notification (e.g., click, tap, or otherwise select the notification to launch requestor application 800) to modify the position of their entry in the queue (e.g., to allow for delayed departure) or remove their entry from the queue. Notably, the user may use requestor application 800 to set the predetermined position of the entry within the queue based on which the wait time is calculated to allow themselves an additional time buffer (e.g., to account for different walking speeds). The different modules may indicate successful completion of their respective tasks, as indicated by arrows 836, 834, and 831.

While the user travels towards the walk-up location, requestor application 800 may provide data indicative of updated locations of the computing device associated with the user, as indicated by arrow 837. Queue entries module 804 may, based on the updated location of the computing device, adjust a position of the user's entry in the queue, as indicated by block 839. Queue entries module 804 may confirm receipt of the updated location, and may transmit any updates in the position of the entry in the queue to requestor application 800, as indicated by arrow 838. Notably, queue entries closer to the head of the queue may be planned to be addressed earlier than queue entries closer to the tail of the queue.

Specifically, queue entries module 804 may determine a time until arrival (i.e., an arrival time) of the computing device at the walk-up location based on the updated location. Queue entries module 804 may also determine an updated wait time for the user's entry based on changes in the state of the queue. When the time until arrival exceeds the updated wait time, the user's entry may be moved down in the queue to avoid a technician taking up the entry before the user arrives at the walk-up location. When the updated wait time exceeds the arrival time, the user's entry may be moved up in the queue to avoid the user arriving before a technician is available to take up the user's entry. When the updated wait time and the arrival time are equal, the entry's position within the queue may remain unchanged.

Such adjustments in the entry's position may account for variations in the user's travel speed, errors in determination of the location of the user's computing device, and variations in the rate of resolution of the entries in the queue, among other possibilities. Additionally, such adjustments may facilitate scheduling of multiple users with technician at the walk-up location, allowing both early and late arrivals to be predicted and accounted for to reduce or minimize the time users spend waiting at the walk-up location before being helped.

FIG. 8B illustrates fulfiller application 810, walk-up locations module 802, queue entries module 804, notification manager module 806, and notification module 808 communicating amongst each other to assign entries, close entries, and abandon entries. Fulfiller application 810 may represent a software application configured to be used to manage entries for the walk-up location associated with managed network 300. That is, fulfiller application 810 may be the software application used by the technical support staff to assign entries, close entries, and abandon entries, as well as create catalog requests, as shown in FIG. 8C, and create tasks, as shown in FIG. 8D. Much like requestor application 800, fulfiller application 810 may be executed by a computing device within managed network 300 or within remote network management platform 320. Fulfiller application 810 may be a stand-alone application or a web-based application.

When an entry is ready to be taken up and addressed by a member of the technical staff at the walk-up location (i.e., a technician), fulfiller application 810 may be used to assign the entry to the technician. The assignment may be performed using a user interface of fulfiller application 810 by, for example, the technician who is taking on the entry, a member of the technical staff in charge of technician assignment, or automatically by fulfiller application 810 or queue entries module 804, among other possibilities. An entry may be assigned to a technician based on the technician's availability and area of technical expertise, among other factors.

Notably, the entry may be assigned to the technician when the user associated with the entry (e.g., the user that has the issue) arrives at and/or is present at the walk-up location. Otherwise, when the user is not present at the walk-up location, the entry might be moved back down one or more spots in the queue or may be abandoned. To that end, the user may be notified, for example, when their entry reaches a preset ordinal position in the queue, when their wait time drops below a threshold time value, or when their travel time meets or exceeds their wait time, as previously described. Queue entries module 804 and notification manager 806 may be configurable by way of the requestor application 800 to set a value for the preset ordinal position and the threshold time value. Queue entries module 804 and notification manager 806 may also be configured to transmit, by way of notification module 808, a notification to the user based on the user's preset preferences.

Fulfiller application 810 may transmit, to the queue entries module 804, an indication of the assignment of the entry to the technician, as indicated by arrow 840. Queue entries module 804 may, in response, associate the entry with a unique identifier of the technician assigned to the entry, and may change a state of the entry from, for example, “QUEUED” to “ASSIGNED TO TECHNICIAN.” These states may allow any queries to queue entries module 804 to specify only entries having a desired state (e.g., return only “ASSIGNED TO TECHNICIAN” entries for display in list 714 of user interface 700 and return only “QUEUED” entries for display in queue 716 of user interface 700).

Assignment of the entry to the technician may cause queue entries module 804 to transmit instructions to notification manager 806, as indicated by arrow 842, to provide, by way of notification module 808, a notification of the assignment to the user associated with the now-assigned entry, as indicated by arrow 844. In response, the user may receive, by way of one or more computing devices, an SMS, email, and/or push notification indicating that the user's entry has been assigned to a technician. The different modules may indicate successful completion of their respective tasks, as indicated by arrows 845, 843, and 841.

Similarly, when a user's issue is resolved, a technician may use fulfiller application 810 to close or resolve the corresponding entry, as indicated by arrow 846. Fulfiller application 810 may receive, from the technician and by way of a user interface, an indication that the entry is to be closed. Accordingly, fulfiller application 810 may transmit to queue entries module 804 an indication that the status of the entry should be changed from, for example, “ASSIGNED TO TECHNICIAN” to “RESOLVED.” In some implementations, closing the entry may involve removing the entry from the database of queue entries module 804 and archiving the entry in another database for later analysis. Queue entries module 804 may, in response to receiving such instructions from fulfiller application 810, change the status of the entry, archive the entry, and/or delete the entry. Queue entries module 804 may also transmit instructions to notification manager 806, as indicated by arrow 848, to provide, by way of notification module 808, a notification to the user that created the entry informing the user that the entry has been closed, as indicated by arrow 850. In response, the user may receive, by way of one or more computing devices, an SMS, email, and/or push notification indicating that the user's entry has been resolved or closed. The different modules may indicate successful completion of their respective tasks, as indicated by arrows 851, 849, and 847.

When a user is not present at the walk-up location when their entry reaches the head of the queue and they are called up by a technician, the user's entry may be abandoned. That is, the technician may use fulfiller application 810 to abandon the entry for which the user who reported the issue (or another related user) is not present at the walk-up location. Abandoning the entry may involve fulfiller application 810 transmitting, to queue entries module 804, instructions to change the statues of the entry from “QUEUED” to, for example “ABANDONED,” to delete the entry from the database entirely, and/or to archive the entry, as indicated by arrow 852. Notification manager 806 and notification module 808 may be used to transmit, to the user associated with the entry, a notification that the entry has been abandoned, as indicated by arrows 854 and 856. Notification module 808, notification manager 806, and queue entries module 804 may transmit indications of completion of their respective tasks, as indicated by arrows 857, 855, and 853, respectively.

Fulfiller application 810 may additionally be used to define or modify business hours associated with a particular walk-up location by transmitting a corresponding request to walk-up locations module 802. Similarly, fulfiller application 810 may be used to indicate that technicians are temporarily unavailable at a walk-up location by transmitting a corresponding request to walk-up locations module 802 or queue entries module 804. The request may indicate, among other information, a time at which the technicians are expected to be available and a reason for the unavailability.

After the technician initiates work on a user's issue, the technician may determine that the issue may be resolved by completing one or more tasks and/or procuring (i.e., ordering and receiving) one or more catalog items. That is, the technician may divide the user's issue into one or more sub-issues, each of which may be resolved by completing a task or acquiring a catalog item. A task may define work to be completed to resolve an issue or sub-issue. The task may be one of a series of tasks that, when completed, resolve the issue or sub-issue. A catalog item may be computer hardware or software that, when procured, may resolve an issue or sub-issue. Procured computer hardware may resolve the issue or sub-issue by, for example, replacing faulty hardware.

FIG. 8C illustrates fulfiller application 810, queue entries module 804, queue entry association module 812, and catalog items module 814 being used to create one or more catalog requests corresponding to an entry. Each of these modules may be hosted, executed, operated, or otherwise provided by way of one or more computational instances within remote network management platform 320 that are assigned to managed network 300, and/or one or more computing devices within managed network 300.

A technician may use fulfiller application 810 to create, for a particular entry of the entries stored by queue entries module 804, a request for one or more catalog item that may be able to address or resolve the particular entry. The request may be transmitted from fulfiller application 810 to queue entries module 804, as indicated by arrow 858. In response, queue entries module 804 may transmit, to catalog items module 814, a first request for a first catalog item, as indicated by arrow 860. In some implementations, the requests indicated by arrows 858 and 860 may be combined into a single request transmitted directly from fulfiller application 810 to catalog items module 814.

Catalog items module 814 may include a database storing representations of a plurality of hardware or software catalog items that can be found at and/or ordered for the walk-up location or for users within managed network 300. The catalog items may include various computing devices such as phones, tablets, laptop computers, desktop computers, head-mountable devices, and watches, among other possibilities. The catalog items may also include various hardware components such as power adapters, speakers, headphones, audio cables, video cables, keyboards, computer mice, monitors, computer docking stations, hard drives, random access memory, processors, and disk drives, among other possibilities. The catalog items may further include various consumable items such as batteries or printer ink cartridges, among other possibilities.

In response to receiving the request at arrow 860, catalog items module 814 may search and determine whether a particular catalog item is available in one or more inventories within or associated with managed network 300. Examples of inventories associated with managed network 300 may include a stockroom at the walk-up location or another nearby stockroom (e.g., within a threshold distance of) the walk-up location. When the particular catalog item is available in inventory associated with managed network 300, catalog items module 814 may automatically reserve the requested catalog item. A technician may retrieve the requested catalog item, provide it to the user, and indicate, using fulfiller application 810, that the requested catalog item has been procured, thus resolving the record for the particular catalog item in the catalog items module 814.

In some cases, the catalog item might not be available in inventory associated with managed network 300 and may thus need to be ordered from an outside vendor. In such a case, catalog items module 814 may be configured to place an order for the requested catalog item. The order may indicate for the requested catalog item to be transported to the walk-up location handling the corresponding entry, or to another convenient walk-up location. Once the ordered catalog item arrives at the walk-up location, the user may be notified, the ordered catalog item may be provided to the user, and the record for the ordered catalog item may be resolved in catalog items module 814.

After the first catalog item is located or ordered, catalog items module 814 may transmit a confirmation to queue entries module 804, as indicated by arrow 861. Queue entries module 804 may then associate the entry with the located or ordered catalog item using queue entry association module 812, as indicated by arrow 862. Queue entry association module 812 may include a database that associates entries with one or more catalog items. When a requested catalog item becomes available (e.g., arrives at the walk-up location), the catalog item may be mapped back to the entry for which it was ordered, and the corresponding user who initially reported the issue may be notified using notification manager 806 and notification module 808. Associating a catalog item with an entry may also operate to temporarily reserve the catalog item for the user, thus preventing the catalog item from being used by another technician before the catalog item is provided to the user. Successful association of the ordered catalog item with the entry may be confirmed by the queue entry association module 812, as indicated by arrow 863.

The operations described with respect to arrows 860-863, may be repeated one or more additional times, as indicated by arrows 864, 865, 866, and 867, to request one or more additional catalog items needed to resolve the issue associated with the entry. Accordingly, a plurality of catalog items may be requested for a single entry without having to create multiple redundant entries for each catalog item needed. When all catalog items requested for the entry are procured or ordered, queue entries module 804 may indicate completion of the procurement and order to fulfiller application 810, as indicated by arrow 859.

In some implementations, each catalog item may be associated with a plurality of entries. Namely, when multiple users each report the same issue that can be fixed by replacing one or more hardware components, each entry corresponding to this issue may be associated with the catalog item requests for the one or more hardware components. For example, an outage of a wireless network in a portion of a building may be reported by a plurality of users located in that portion. Fixing the outage may involve replacing one or more wireless routers in that portion of the building. Each entry from the plurality of users may be associated with the one or more wireless routers so that when the routers are procured, each of the plurality of users may be notified and their corresponding entries resolved.

FIG. 8D illustrates fulfiller application 810, queue entries module 804, queue entry association module 812, and tasks module 816 being used to create a plurality of tasks corresponding to an entry. Like the other modules, tasks module 816 may be hosted, executed, operated, or otherwise provided by way of one or more computational instances within remote network management platform 320 that are assigned to managed network 300, and/or one or more computing devices within managed network 300.

A technician may use fulfiller application 810 to create, for a particular entry of the entries stored in queue entries module 804, a request for one or more tasks to be completed to address or resolve the particular entry. The request may be transmitted from fulfiller application 810 to queue entries module 804, as indicated by arrow 868. In response, queue entries module 804 may transmit, to tasks module 816, a first request for a first task, as indicated by arrow 870. In some implementations, the requests indicated by arrows 868 and 870 may be combined into a single request transmitted directly from fulfiller application 810 to catalog items module 814.

Tasks module 816 may include a database storing representations of a plurality of tasks to be completed by one or more users or technicians within managed network 300 or remote network management platform 320. The tasks maybe selected from a predetermined list of tasks (e.g., create account, change password, grant privileges to access a service, etc.) or the tasks may be defined on a case-by-case basis. The task may be assigned to a technician at the walk-up location attended by the user requesting assistance, a technician at another walk-up location, an individual within another department associated with managed network 300 (e.g., an individual within the human resources (HR) department who can grant user permissions for the HR software), or an individual associated within remote network management platform 320 (i.e., a technician or programmer for remote network management platform 320).

After the first task is created, tasks module 816 may transmit a confirmation of the created task to queue entries module 804, as indicate by arrow 871. Queue entries module 804 may then associate the entry with the created task using queue entry association module 812, as indicated by arrow 872. Queue entry association module 812 may include a database that associates entries with one or more tasks. Thus, when a task is completed, the completed task may be mapped back to the entry for which it was created, and the corresponding user who initially reported the issue may be notified using notification manager 806 and notification module 808. Successful association of the task with the entry may be confirmed by the queue entry association module 812, as indicated by arrow 873.

The operations described with respect to arrows 870-873 may be repeated one or more additional times, as indicated by arrows 874, 875, 876, and 877, to create one or more additional tasks needed to resolve the issue associated with the entry. When all tasks for the entry are created, queue entries module 804 may indicate completion of the request to create tasks to fulfiller application 810, as indicated by arrow 869.

Accordingly, a plurality of tasks may be created for a single entry without having to create multiple redundant entries for each task. Additionally, each task may be assigned to a different technician or individual capable of completing the task. This assignment may be stored in queue entry association module 812 or queue entries module 804, among other possibilities. Thus, each user issue may be divided up among a plurality of technicians that are well-suited for addressing the individual tasks, thereby facilitating speedy resolution of the issue. Further, since each task may be assigned to a different technician, this approach allows for the operations of the staff of multiple different departments (e.g., information technology and human resources) within an entity to be synchronized together, and also allows the operations of the staff of one entity (e.g., the entity associated with managed network 300) to synchronize with operations of staff of another different entity (e.g., the entity associated with remote network management platform 320).

In some embodiments, the tasks of tasks module 816 and the catalog items of catalog items module 814 may include dependencies indicating an order in which the tasks and catalog items may need to be completed or fulfilled. For example, initiation or completion of a second task may depend on initiation or completion of a first task (e.g., configuring a user's desk phone to be forwarded to the user's cell phone may depend on first configuring the user's desk phone to handle the call forwarding). Similarly, initiation or completion of a task may depend on availability of a catalog item (e.g., installing an updated version of a software program may depend on first installing additional random access memory on a user's computer). Such dependencies between the tasks and/or catalog items may be stored, for example, in queue entry association module 812. When a first task on which a second task depends is completed (or an item on which the second task depends arrives), the individual to which the second task is assigned may be notified, using, for example, fulfiller application 810, that the individual is now able to initiate work on the second task, and the second task may be added to the individual's personal queue of tasks to be completed. Accordingly, parts of a technical issue may be addressed by multiple different technicians without the technicians needing to actively communicate or schedule with one another.

In some implementations, the process of generating tasks and/or requesting catalog items for an entry may be performed automatically by one or more of fulfiller application 810 or queue entries module 804, among other possibilities. For example, an entry may be determined to correspond to one of a plurality of known issues associated with predefined workflows (i.e., series of tasks and lists of catalog items needed to resolve the issues). When a user reports such a known issue, the tasks and catalog items needed to resolve the issue may be automatically generated and assigned to technicians.

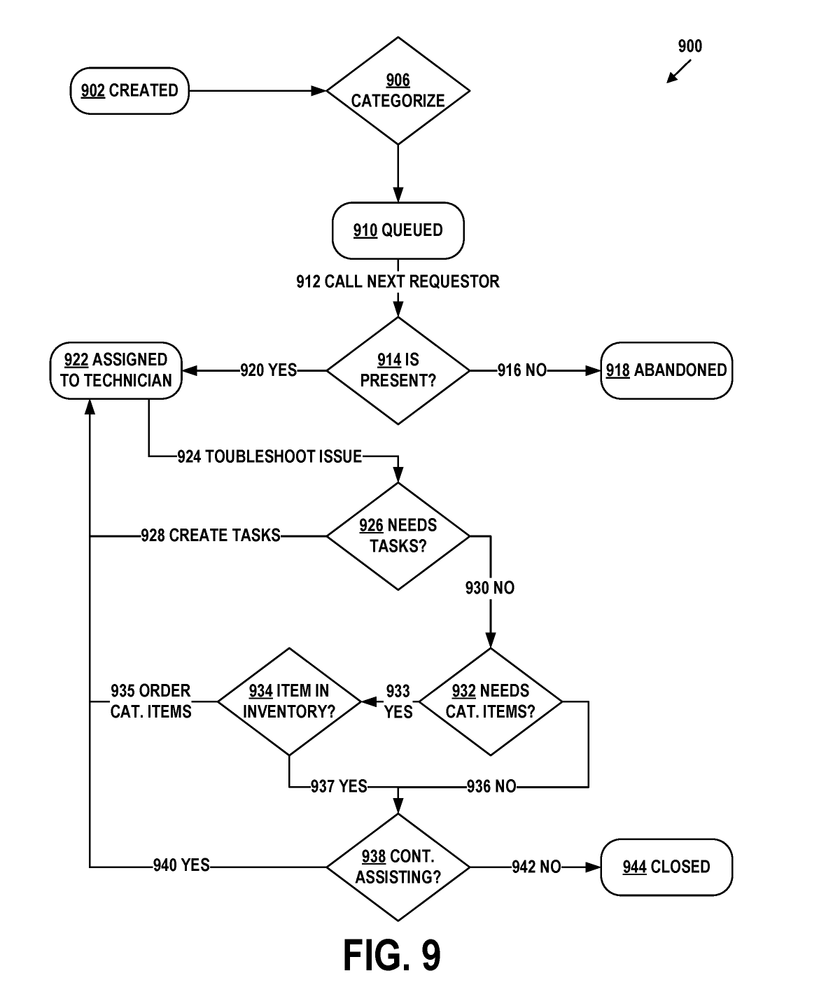

FIG. 9 illustrates an example flow chart 900 of operations that may be performed for an example issue submitted to a walk-up location by a user. The operations of flow chart 900 may be performed by one or more of requestor application 800, fulfiller application 810, walk-up locations module 802, queue entries module 804, notification manager 806, notification module 808, catalog items module 814, queue entry association module 812, or tasks module 816.

At block 902, an entry may be created based on a technical issue reported by the user. The entry may be assigned a state “NEW” or “CREATED” to indicate that the issue has been received, but has not yet been categorized or inserted into the queue. After being created, the entry may undergo a categorization, as indicated by block 906. The categorization may involve grouping the entry into a specific technical area (e.g., hardware support, software support, networking support, etc.) and/or determining whether the entry should be prioritized in any way based on, for example, a priority level associated with the individual requesting support. After such categorization, the entry may be placed in a queue and assigned a state “QUEUED,” as indicated by block 910.

When the entry reaches the head of the queue, a technician may call the user associated with the entry, as indicated by arrow 912. When the user is not present, as indicated by block 914 and arrow 916, the entry may be marked as abandoned, as indicated by block 918, and the technician may proceed to call the next user in the queue. The user may be notified of the abandonment, as described with respect to FIG. 8B. Alternatively, the entry may be deferred by moving it down in the queue by one or more spots so as to avoid abandonment.

When the user is present, as indicated by block 914 and arrow 920, the entry may be assigned to a technician, and its state may be changed from “QUEUED” to “ASSIGNED TO TECHNICIAN,” as indicated by block 922. The assigned technician may proceed to troubleshoot the issue, as indicated by arrow 924, and may determine whether one or more tasks are necessary to resolve the issue, as indicated by block 926. If one or more tasks are needed, new tasks may be created, as indicated by arrow 928, and may be assigned to corresponding technicians, as indicated by block 922. Notably, multiple tasks may be created based on a single entry so as to allow multiple technicians, possibly belonging to different departments or located in different geographic areas, to address different sub-issues of the single entry.

If a task is not needed or all needed tasks have already been created, as indicated by arrow 930, the technician may determine whether one or more catalog items are needed to resolve the user's issue, as indicated by block 932. If any catalog items are needed, the inventory may be checked and any readily-available catalog items may be procured or, as indicated by arrow 933 and block 934. If the needed catalog items are not readily available in inventory, the needed catalog items may be ordered, as indicated by arrow 935. The ordered catalog items may be assigned to one or more technicians responsible for following through on the ordering, receipt, and delivery of the catalog items.

If catalog items are not needed or all needed catalog items have already been ordered and/or procured, as indicated by arrows 936 and 937, the technician may determine whether to continue assisting the user, as indicated by block 938. That is, the technician may determine whether to keep the entry corresponding to the user's issue open, as indicated by arrow 940, or close the entry, as indicated by arrow 942 and block 944. In some embodiments, an entry may be kept open until all tasks assigned to the entry are completed and all catalog items needed for the entry are received, at which point the entry may be closed. Alternatively, the entry may be closed when all tasks and catalog items for the entry are generated and ordered, respectively, but not necessarily completed or received, respectively. That is, the entry corresponding to the issue may be closed and replaced by the various tasks and catalog items generated to resolve the issue.

When the user's issue is resolved and/or when the user leaves the walk-up location, the user may be able to fill out a satisfaction survey. In some embodiments, the satisfaction survey may be anonymously provided using one or more computing devices available at the walk-up location. Alternatively, the satisfaction survey may be made available by way of requestor application 800 on the user's computing device. In some embodiments, the user's satisfaction rating may be stored (e.g., in queue entries module 804) and used to determine the user's position in the queue next time the user visits the walk-up location. For example, a dissatisfied user may be placed higher up in the queue next time this dissatisfied user visits the walk-up location as consolation for their dissatisfaction.

### VII. EXAMPLE USER INTERFACE FOR MONITORING A TECHNICAL ISSUE

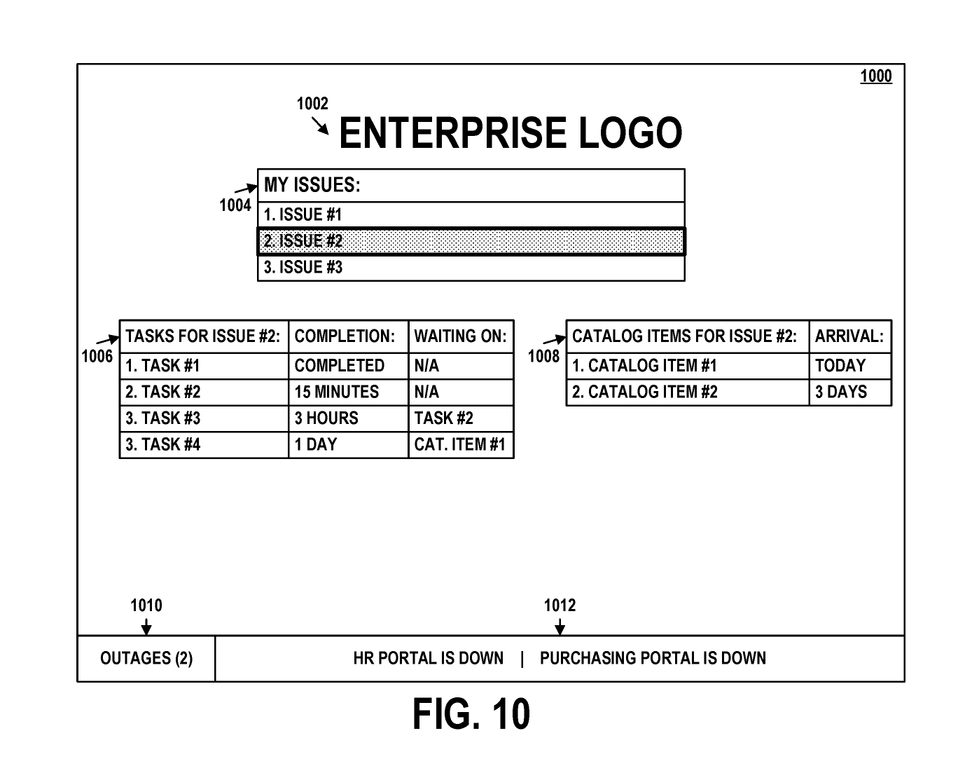

FIG. 10 illustrates an example user interface 1000 that may be used to monitor a status of an entry throughout its life cycle. User interface 1000 includes enterprise logo 1002, issues table 1004, tasks table 1006, catalog items table 1008, as well as outage indicator 1010 and outage details 1012. Each issue in issues table 1004 may correspond to an entry stored by queue entries module 804 and assigned to a particular requestor (i.e., user who submitted the issue) or a particular fulfiller (i.e., technician assigned to resolve the issue). Thus, user interface 1000 may be used by a requestor to monitor the progress of issues that the requestor submitted, and/or by a fulfiller to keep track of issues the fulfiller is assigned to resolve.

User interface 1000 may be used to select one of the issues in issues table 1004 to see the tasks and catalog items corresponding to that issue. For example, ISSUE #2 may be selected, as shown by the dotted pattern around the corresponding entry in issues table 1004. In response to selection of the issue from issue table 1004, tables 1006 and 1008 may be populated with the tasks and catalog items, respectively, corresponding to the selected issue. ISSUE #2 may, for example, involve four tasks, as shown in task table 1006. Task table 1006 may include a column that shows the expected time until completion of each of the tasks, as well as a column that shows any dependencies between tasks. TASK #3, for example, is shown as estimated to be completed in 3 hours and is dependent on completion of TASK #2. TASK #4 is shown as estimated to be completed in one day and is dependent on arrival of CATALOG ITEM #2.

Similarly, ISSUE #2 may involve two catalog items, as shown in catalog item table 1008. Task table 1006 may include a column that shows the expected time until arrival of each of the catalog items. CATALOG ITEM #4, for example, may be expected to arrive at the walk-up location in three days. Although not shown, catalog items may also be dependent on completion of various tasks. For example, purchase of an expensive computer may require approval from the finance department before it may proceed.

Although the various modules and operations are discussed herein in the context of a walk-up location, they may also be applied to other support or fulfillment channels where queuing is important. For example, the operations may be adapted to facilitate technical support by phone or online chat. Additionally, the operations herein described may be used to synchronize multiple different technical support systems (e.g., walk-up and phone). For example, a user may submit their issue to a phone technical support queue. When this issue is addressed by a technician over the phone, various tasks may be generated and assigned to technicians at a nearby walk-up location to facilitate resolution of the issue or procurement of any needed catalog items.

### VIII. ADDITIONAL EXAMPLE OPERATIONS

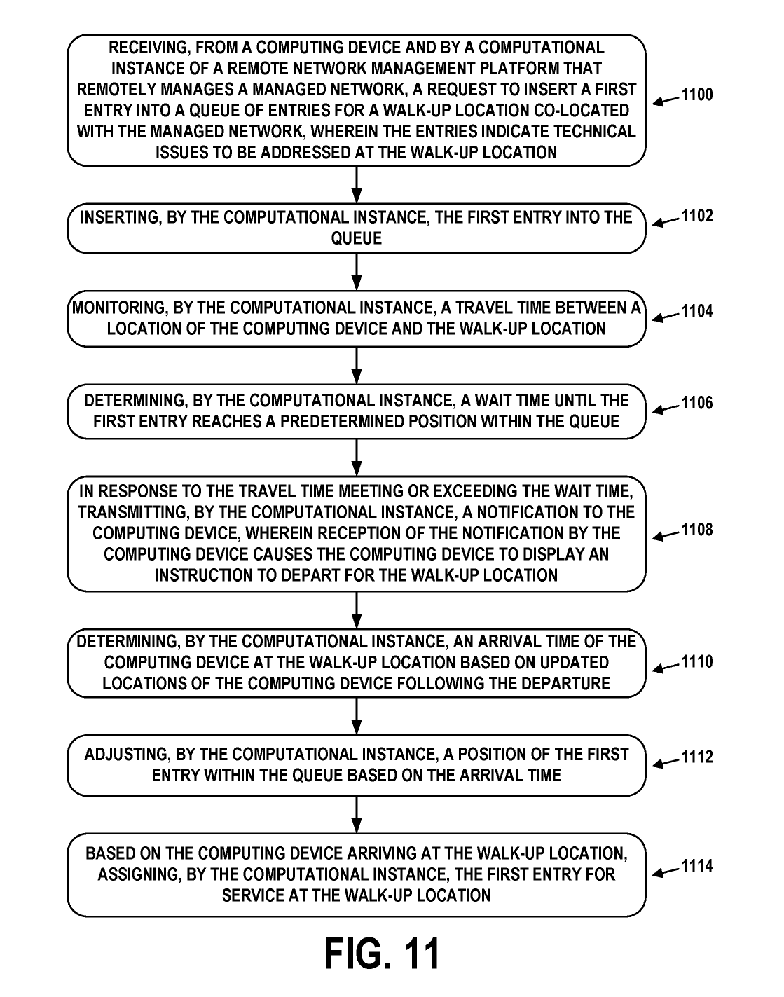

FIG. 11 is a flow chart illustrating an example embodiment. The process illustrated by FIG. 11 may be carried out by a computing device, such as computing device 100, and/or a cluster of computing devices, such as server cluster 200. However, the process can be carried out by other types of devices or device subsystems. For example, the process could be carried out by a portable computer, such as a laptop or a tablet device. The process could also be carried out by a combination of one or more software modules within a computational instance (e.g., computational instance 322) assigned to managed network 300.

The embodiments of FIG. 11 may be simplified by the removal of any one or more of the features shown therein. Further, these embodiments may be combined with features, aspects, and/or implementations of any of the previous figures or otherwise described herein.

Block 1100 may involve receiving, from a computing device and by a computational instance of a remote network management platform that remotely manages a managed network, a request to insert a first entry into a queue of entries for a walk-up location co-located with the managed network. The entries may indicate technical issues to be addressed at the walk-up location.

Block 1102 may involve inserting, by the computational instance, the first entry into the queue.

Block 1104 may involve monitoring, by the computational instance, a travel time between a location of the computing device and the walk-up location.

Block 1106 may involve determining, by the computational instance, a wait time until the first entry reaches a predetermined position within the queue.

Block 1108 may involve, in response to the travel time meeting or exceeding the wait time, transmitting, by the computational instance, a notification to the computing device. Reception of the notification by the computing device may cause the computing device to display an instruction to depart for the walk-up location.

Block 1110 may involve determining, by the computational instance, an arrival time of the computing device at the walk-up location based on updated locations of the computing device following the departure.

Block 1112 may involve adjusting, by the computational instance, a position of the first entry within the queue based on the arrival time.

Block 1114 may involve, based on the computing device arriving at the walk-up location, assigning, by the computational instance, the first entry for service at the walk-up location.

In some embodiments, the computational instance may receive, from a second computing device associated with the walk-up location, instructions to generate a plurality of tasks. Completion of the plurality of tasks may be expected to resolve at least part of the technical issue indicated by the first entry. The computational instance may generate the plurality of tasks in response to receiving a request to generate the plurality of tasks. The computational instance may also associate each respective task of the plurality of tasks with (i) the first entry and (ii) at least one technician of the one or more technicians, where the at least one technician is assigned to complete the respective task.

In some embodiments, the computational instance may receive, from a second computing device associated with the walk-up location, instructions to generate a plurality of catalog items to be obtained. Obtainment of the plurality of catalog items may be expected to resolve at least part of the technical issue indicated by the first entry. The computational instance may, in response to receiving a request to obtain the plurality of catalog items, determine a first subset of the plurality of catalog items and a second subset of the plurality of catalog items. Catalog items of the first subset are to be obtained from inventory associated with the managed network. Catalog items of the second subset are to be obtained from outside of the inventory. The computational instance may reserve catalog items of the first subset from the inventory and generate an order for catalog items of the second subset to be obtained from outside of the inventory. The computational instance may associate each respective catalog item of the plurality of catalog items with the first entry.

In some embodiments, the first entry may be associated with a plurality of tasks. Each task of the plurality of tasks may be assigned a technician to complete the task. Performance of a first tasks of the plurality of tasks may be dependent on completion of a second task of the plurality of tasks. In response to completion of the second task, the computational instance may transmit a second notification to a second computing device associated with the technician assigned to complete the first task. Reception of the second notification may cause the second computing device to display an instruction to initiate performance of the first task.

In some embodiments, the first entry may be associated with one or more tasks and one or more catalog items. Each task of the one or more tasks may be assigned a technician to complete the task. Performance of a first task of the one or more tasks may be dependent on obtainment of a first catalog item of the one or more catalog items. In response to obtainment of the first catalog item, the computational instance may transmit a second notification to a second computing device associated with the technician assigned to complete the first task. Reception of the second notification may cause the second computing device to display an instruction to initiate performance of the first task.

In some embodiments, monitoring the travel time between the location of the computing device and the walk-up location may involve receiving, from the computing device, data representing the location of the computing device, determining distance between the location of the computing device and the walk-up location, and determining the travel time for traversing the distance at a predetermined walking speed.

In some embodiments, the queue of entries may include a first sub-queue of entries awaiting assignment for service at the walk-up location and a second sub-queue of entries assigned for service at the walk-up location. The computational instance may insert the first entry into the queue by inserting the first entry into the first sub-queue. The computational instance may assign the first entry for service at the walk-up location by removing the first entry from the first sub-queue and inserting the first entry into the second sub-queue.

In some embodiments, assigning the first entry for service at the walk-up location may involve, based on the computing device arriving at the walk-up location, transmitting a second notification to a second computing device associated with the walk-up location. Reception of the second notification by the second computing device may cause the second computing device to display an indication of the computing device arriving at the walk-up location. Instructions to assign the computing device to a first technician of one or more technicians at the walk-up location may be received from the second computing device. The computing device may be assigned to the first technician.

In some embodiments, adjusting the position of the first entry within the queue based on the arrival time may involve determining an updated wait time until the first entry reaches a head of the queue, moving the first entry closer to a tail of the queue when the arrival time exceeds the updated wait time, and moving the first entry closer to a head of the queue when the updated wait time exceeds the arrival time.

In some embodiments, in response to receiving the request to insert the first entry into the queue, the computational instance may identify one or more troubleshooting guides to assist in resolution of the technical issue indicated by the first entry. The computational instance may transmit the one or more troubleshooting guides to the computing device.

In some embodiments, the computational instance may receive, from a second computing device associated with the walk-up location, an indication of resolution of the technical issue associated with the first entry. In response to receiving the indication of resolution, the computational instance may remove the first entry from the queue.

In some embodiments, a request to view the queue may be received by the computational instance. In response to receiving the request to view the queue, the computational instance may transmit, to the computing device, (i) first data representing the queue and (ii) second data representing system-wide outages within the managed network. Reception of the first and second data may cause the computing device to display, by way of a user interface and in respective sections thereof, the queue and an indication of the system-wide outages.

In some embodiments, inserting the first entry into the queue may involve determining a position within the queue for the first entry based on at least one of (i) a priority corresponding to the technical issue associated with the first entry and (ii) a priority corresponding to a user identity associated with the computing device, and inserting the first entry into the queue at the determined position.

In some embodiments, after resolution of the technical issue associated with the first entry, the computational instance may transmit a satisfaction survey to the computing device. The computational instance may receive, from the computing device, responses to the satisfaction survey based on resolution of the technical issue associated with the first entry. The computational instance may receive, from the computing device, a subsequent request to insert a second entry into the queue. The second entry may be associated with another technical issue. The computational instance may determine a position in the queue for the second entry based on the responses to the satisfaction survey and insert the second entry into the queue at the determined position.

In some embodiments, the queue may be a first queue of a plurality of queues. Each queue of the plurality of queues may correspond to a respective type of technical issue of a plurality of different types of technical issues. Inserting the first entry into the first queue may involve classifying the technical issue associated with the first entry as a first type of technical issue of the plurality of different types of technical issues. Based on the classification of the technical issue as the first type of technical issue, the first queue may be selected from the plurality of queues. The first queue may correspond to the first type of technical issue. The first entry may be inserted into the first queue.

In some embodiments, the computational instance may receive, from the computing device, a selection of the predetermined position within the queue.

In some embodiments, the computational instance may be configured to transmit notifications by way of one or more notification channels. The computational instance may also be configured to (i) select one or more of the notification channels based on pre-set parameters associated with the computing device and (ii) transmit the notification to the computing device by way of the one or more selected notification channels.

In some embodiments, a system may include means for receiving, from a computing device, a request to insert a first entry into a queue of entries for a walk-up location co-located with a managed network. The entries may indicate technical issues to be addressed at the walk-up location. The managed network may be managed by a remote network management platform. The system may also include means for inserting the first entry into the queue. The system may additionally include means for monitoring a travel time between a location of the computing device and the walk-up location. The system may yet additionally include means for determining a wait time until the first entry reaches a predetermined position within the queue. The system may further include means for, in response to the travel time meeting or exceeding the wait time, transmitting a notification to the computing device. Reception of the notification by the computing device may cause the computing device to display an instruction to depart for the walk-up location. The system may yet further include means for determining an arrival time of the computing device at the walk-up location based on updated locations of the computing device following the departure. The system may include means for adjusting a position of the first entry within the queue based on the arrival time and means for, based on the computing device arriving at the walk-up location, assigning the first entry for service at the walk-up location.

### IX. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computing system disposed within a computational instance of a remote network management platform that remotely manages a managed network, the computing system comprising:
a database storing a queue of entries for a walk-up location co-located with the managed network, wherein the entries indicate technical issues to be addressed at the walk-up location; and
a queue management software module configured to:
receive, from a computing device, a request to insert a first entry into the queue;
insert the first entry into the queue;
monitor a travel time between a location of the computing device and the walk-up location;
determine a wait time until the first entry reaches a predetermined position within the queue;
in response to the travel time meeting or exceeding the wait time, transmit a notification to the computing device, wherein reception of the notification by the computing device causes the computing device to display an instruction to depart for the walk-up location;
determine an arrival time of the computing device at the walk-up location based on updated locations of the computing device following the departure;
adjust a position of the first entry within the queue based on the arrival time; and
based on the computing device arriving at the walk-up location, assign the first entry for service at the walk-up location.

2. The computing system of claim 1, wherein the queue management software module is further configured to receive, from a second computing device associated with the walk-up location, instructions to generate a plurality of tasks, wherein completion of the plurality of tasks is expected to resolve at least part of the technical issue indicated by the first entry, and wherein the system further comprises:
a tasks module configured to generate the plurality of tasks in response to receiving, from the queue management software module, a request to generate the plurality of tasks; and
a queue entry association module configured to associate each respective task of the plurality of tasks with (i) the first entry and (ii) at least one technician of the one or more technicians, wherein the at least one technician is assigned to complete the respective task.

3. The computing system of claim 1, wherein the queue management software module is further configured to receive, from a second computing device associated with the walk-up location, instructions to generate a plurality of catalog items to be obtained, wherein obtainment of the plurality of catalog items is expected to resolve at least part of the technical issue indicated by the first entry, and wherein the system further comprises:
a catalog items module configured to:
in response to receiving, from the queue management software module, a request to obtain the plurality of catalog items, determine a first subset of the plurality of catalog items and a second subset of the plurality of catalog items, wherein catalog items of the first subset are to be obtained from inventory associated with the managed network, and wherein catalog items of the second subset are to be obtained from outside of the inventory;
reserve catalog items of the first subset from the inventory; and
generate an order for catalog items of the second subset to be obtained from outside of the inventory; and
a queue entry association module configured to associate each respective catalog item of the plurality of catalog items with the first entry.

4. The computing system of claim 1, wherein the first entry is associated with a plurality of tasks, wherein each task of the plurality of tasks is assigned a technician to complete the task, wherein performance of a first tasks of the plurality of tasks is dependent on completion of a second task of the plurality of tasks, and wherein the queue management software module is further configured to:
in response to completion of the second task, transmit a second notification to a second computing device associated with the technician assigned to complete the first task, wherein reception of the second notification causes the second computing device to display an instruction to initiate performance of the first task.

5. The computing system of claim 1, wherein the first entry is associated with one or more tasks and one or more catalog items, wherein each task of the one or more tasks is assigned a technician to complete the task, wherein performance of a first task of the one or more tasks is dependent on obtainment of a first catalog item of the one or more catalog items, and wherein the queue management software module is further configured to:
in response to obtainment of the first catalog item, transmit a second notification to a second computing device associated with the technician assigned to complete the first task, wherein reception of the second notification causes the second computing device to display an instruction to initiate performance of the first task.

6. The computing system of claim 1, wherein the queue management software module is configured to monitor the travel time between the location of the computing device and the walk-up location by:
receiving, from the computing device, data representing the location of the computing device;
determining a distance between the location of the computing device and the walk-up location; and
determining the travel time for traversing the distance at a predetermined walking speed.

7. The computing system of claim 1, wherein the queue of entries comprises a first sub-queue of entries awaiting assignment for service at the walk-up location and a second sub-queue of entries assigned for service at the walk-up location, wherein the queue management software module is configured to insert the first entry into the queue by inserting the first entry into the first sub-queue, and wherein the queue management software module is configured to assign the first entry for service at the walk-up location by:
removing the first entry from the first sub-queue; and
inserting the first entry into the second sub-queue.

8. The computing system of claim 1, wherein the queue management software module is configured to assign the first entry for service at the walk-up location by:
based on the computing device arriving at the walk-up location, transmitting a second notification to a second computing device associated with the walk-up location, wherein reception of the second notification by the second computing device causes the second computing device to display an indication of the computing device arriving at the walk-up location;
receiving, from the second computing device, instructions to assign the computing device to a first technician of one or more technicians at the walk-up location; and
assigning the computing device to the first technician.

9. The computing system of claim 1, wherein the queue management software module is configured to adjust the position of the first entry within the queue based on the arrival time by:
determining an updated wait time until the first entry reaches a head of the queue;
moving the first entry closer to a tail of the queue when the arrival time exceeds the updated wait time; and
moving the first entry closer to a head of the queue when the updated wait time exceeds the arrival time.

10. The computing system of claim 1, wherein the queue management software module is further configured to:
in response to receiving the request to insert the first entry into the queue, identify one or more troubleshooting guides to assist in resolution of the technical issue indicated by the first entry; and
transmit the one or more troubleshooting guides to the computing device.

11. The computing system of claim 1, wherein the queue management software module is further configured to:
receive, from a second computing device associated with the walk-up location, an indication of resolution of the technical issue associated with the first entry; and
in response to receiving the indication of resolution, removing the first entry from the queue.

12. The computing system of claim 1, wherein the queue management software module is further configured to:
receive a request to view the queue; and
in response to receiving the request to view the queue, transmit, to the computing device, (i) first data representing the queue and (ii) second data representing system-wide outages within the managed network, wherein reception of the first and second data causes the computing device to display, by way of a user interface and in respective sections thereof, the queue and an indication of the system-wide outages.

13. The computing system of claim 1, wherein the queue management software module is configured to insert the first entry into the queue by:
determining a position within the queue for the first entry based on at least one of (i) a priority corresponding to the technical issue associated with the first entry and (ii) a priority corresponding to a user identity associated with the computing device; and
inserting the first entry into the queue at the determined position.

14. The computing system of claim 1, wherein the queue management software module is further configured to:
after resolution of the technical issue associated with the first entry, transmit a satisfaction survey to the computing device;
receive, from the computing device, responses to the satisfaction survey based on resolution of the technical issue associated with the first entry;
receive, from the computing device, a subsequent request to insert a second entry into the queue, wherein the second entry is associated with another technical issue;
determine a position in the queue for the second entry based on the responses to the satisfaction survey; and
insert the second entry into the queue at the determined position.

15. The computing system of claim 1, wherein the queue is a first queue of a plurality of queues, wherein each queue of the plurality of queues corresponds to a respective type of technical issue of a plurality of different types of technical issues, and wherein the queue management software module is configured to insert the first entry into the first queue by:
classifying the technical issue associated with the first entry as a first type of technical issue of the plurality of different types of technical issues; and
based on the classification of the technical issue as the first type of technical issue, selecting the first queue from the plurality of queues, wherein the first queue corresponds to the first type of technical issue; and
inserting the first entry into the first queue.

16. The computing system of claim 1, wherein the queue management software module is further configured to:
receive, from the computing device, a selection of the predetermined position within the queue.

17. The computing system of claim 1, further comprising:
a notification module configured to transmit notifications by way of one or more notification channels; and
a notification manager configured to (i) select one or more of the notification channels provided by the notification module based on pre-set parameters associated with the computing device and (ii) instruct the notification module to transmit the notification to the computing device by way of the one or more selected notification channels,
wherein the queue management software module is configured to transmit the notification to the computing device by transmitting, to the notification manager, a content of the notification.

18. A method comprising:
receiving, from a computing device and by a computational instance of a remote network management platform that remotely manages a managed network, a request to insert a first entry into a queue of entries for a walk-up location co-located with the managed network, wherein the entries indicate technical issues to be addressed at the walk-up location;
inserting, by the computational instance, the first entry into the queue;
monitoring, by the computational instance, a travel time between a location of the computing device and the walk-up location;
determining, by the computational instance, a wait time until the first entry reaches a predetermined position within the queue;
in response to the travel time meeting or exceeding the wait time, transmitting, by the computational instance, a notification to the computing device, wherein reception of the notification by the computing device causes the computing device to display an instruction to depart for the walk-up location;
determining, by the computational instance, an arrival time of the computing device at the walk-up location based on updated locations of the computing device following the departure;
adjusting, by the computational instance, a position of the first entry within the queue based on the arrival time; and
based on the computing device arriving at the walk-up location, assigning, by the computational instance, the first entry for service at the walk-up location.

19. The method of claim 18, further comprising:
receiving, from a second computing device associated with the walk-up location, instructions to generate a plurality of tasks to be completed by one or more technicians, wherein completion of the plurality of tasks is expected to resolve at least part of the technical issue indicated by the first entry;
generating the plurality of tasks in response to receiving the instructions to generate the plurality of tasks; and
associating each respective task of the plurality of tasks with (i) the first entry and (ii) at least one technician of the one or more technicians, wherein the at least one technician is assigned to complete the respective task.

20. An article of manufacture including a non-transitory computer-readable medium, having stored thereon program instructions that, upon execution by a computing system, cause the computing system to perform operations comprising:
receiving, from a computing device, a request to insert a first entry into a queue of entries for a walk-up location co-located with a managed network, wherein the entries indicate technical issues to be addressed at the walk-up location;
inserting the first entry into the queue;
monitoring a travel time between a location of the computing device and the walk-up location;
determining a wait time until the first entry reaches a predetermined position within the queue;
in response to the travel time meeting or exceeding the wait time, transmitting a notification to the computing device, wherein reception of the notification by the computing device causes the computing device to display an instruction to depart for the walk-up location;
determining an arrival time of the computing device at the walk-up location based on updated locations of the computing device following the departure;
adjusting a position of the first entry within the queue based on the arrival time; and
based on the computing device arriving at the walk-up location, assigning the first entry for service at the walk-up location.
